(19) United States
(12) Patent Application Publication
(10) Pub. No.: US 2025/0305146 A1
(43) Pub. Date: Oct. 2, 2025

(54) N-HETEROCYCLIC CARBENES DEPOSITION ON COPPER POWDER SURFACE

(71) Applicants: THE ROYAL INSTITUTION FOR THE ADVANCEMENT OF LEARNING/MCGIL UNIVERSITY, Montreal (CA); CONCORDIA UNIVERSITY, Montreal (CA)

(72) Inventors: Janine MAUZEROLL, Montreal (CA); Yuanjiao LI, Montreal (CA); Jashanpreet KAUR, Montreal (CA); Vikram SINGH, Montreal (CA); Jéssica Soares GUIMARAES SELVA, Montreal (CA); David LEPAGE, Sainte-Julie (CA); Christian MOREAU, Boucherville (CA); Goinoush ASADIANKOUHIDEHKORDI, Montreal (CA); Andre C. LIBERATI, Chatuzange-le-Goubet (FR)

(21) Appl. No.: 19/094,176

(22) Filed: Mar. 28, 2025

Related U.S. Application Data
(60) Provisional application No. 63/570,985, filed on Mar. 28, 2024.

(51) Int. Cl. C23C 26/00; C07F 1/08

(52) U.S. Cl. CPC C23C 26/00; C07F 1/08

(57) ABSTRACT

There is provided a method of producing a N-heterocyclic carbene (NHC) coated metal powder. The method comprises mixing an alcohol solvent, metal powder and a N-heterocyclic carbene (NHC) salt to obtain a NHC coated metal powder.

### CROSS-REFERENCE TO A RELATED APPLICATION

This disclosure claims priority from U.S. provisional application No. 63/570,985 filed on Mar. 28, 2024 which is incorporated herein by reference in its entirety.

### TECHNICAL FIELD

This disclosure relates to the field of surface treatments, particularly the deposition of N-heterocyclic carbenes on metal powders, such as copper powders.

### BACKGROUND OF THE ART

N-heterocyclic carbenes (NHCs) have been used as ligands for metal complexes and nanoparticles for decades, taking advantage of the strong covalent bond to metals and tunable side groups. Recently, the self-assembled layers (SALs) of NHCs have attracted increasing attention as an alternative to thiol analogs on gold due to the considerably chemical and thermal stability. The carbene-gold bonds have been demonstrated to be stable under acidic, alkaline and oxidized conditions, and even at high temperatures up to 300° C.

The ability of NHC to form layers has also been demonstrated on metal surfaces other than gold, such as copper, silver, platinum and magnesium. Among them, NHCs deposition on copper surfaces were extensively studied as its wide industrial applications. In particular, a stable NHC precursor was reported to remove copper oxide and modify the metallic surface under ambient conditions.

Copper powder, as a low-cost industrial material, has a broad range of applications, such as a semiconductor, an electrically conductive paste, and a spray coating, because of the excellent electrical conductivity and relatively higher melting point. However, an oxide layer cannot protect copper from further oxidation, thus the gradual degradation of the metal is inevitable with an oxide layer. Moreover, in certain fields, the presence of a surface oxide layer can negatively affect the performance of copper powder. For instance, when copper powder is used as a spray coating material, the surface oxide layer compromises the internal adhesion of the coating film.

One particular example where copper is extensively used is in the integrated circuit (IC) industry because of its high electric and thermal conductivity. However, self-oxidation is a serious disadvantage associated with Cu, which is not self-limiting and thereby alters its surface properties. Additionally, when oxide is formed at the surface of the copper material, this results in poor performance of the Cu material in a variety of industrial applications such as brazing, bonding, and thermal/cold spray coatings. Therefore, the removal/reduction of surface oxide from the oxidized surfaces is desired.

Thermal spraying is a general term used for different processes to coat raw materials either in powder, wire, or rod form to produce metallic or non-metallic coatings. Among many spraying processes, cold spraying is one of the techniques that results in more uniform metal powder coatings with reduced porosity and increased bond strength. Copper is one of the extensively used materials for cold spraying where corrosion resistance and enhanced thermal as well as electrical conductivity are required. High-purity copper coatings are also used to repair copper-based alloy parts, and in the paper and printing industry, in order to resist corrosive inks.

The use of copper coatings is limited due to its tendency to oxidate under ambient conditions, which can grow with time during the storage period and spraying, due to high temperature. In general, metals or alloys form bonds when the fresh surface of one particle comes in contact with another. Different thicknesses of oxide layers on metal surfaces can influence the extent of bonding between them. Oxidation causes the deterioration of thermal and electrical conductivity because it hinders effective electron transport. Copper coatings without oxides that have a resistance to oxidation are therefore desired.

Various methods have been adopted to remove copper oxides from flat copper surfaces such as H₂ gas treatment, usage of D* and CH₃* radicals for reduction of copper (I) oxide and copper (II) oxide, vacuum annealing of coated films and powders, glacial acetic acid treatment or the acid pickling process for powders. Many of these methods require ultra-high vacuum conditions making them unsuitable for industrial applications and very cost and energy intensive. Accordingly, improvements in copper coating processes, and more generally metal coating processes, are needed in order to obtain non-oxidate coatings which are also not susceptible to oxidation long term such as during storage.

### SUMMARY

In one aspect, there is provided a method of producing a N-heterocyclic carbene (NHC) coated metal powder, the method comprises: mixing an alcohol solvent, metal powder and a N-heterocyclic carbene (NHC) salt to obtain a NHC coated metal powder.

In at least some embodiments, the metal is selected from Ti, Ni, Al, Cu, and Fe and alloys thereof.

In at least some embodiments, the alcohol solvent is selected from methanol, ethanol, butanol or propanol.

In at least some embodiments, the method further comprises separating the NHC coated metal powder from the alcohol solvent.

In at least some embodiments, the mixing is performed at a temperature of from 18 to 25° C.

In at least some embodiments, the mixing is performed at atmospheric pressure.

In at least some embodiments, metal powder has a particle size distribution characterized by a D50 of from 5 to 200 μm.

In at least some embodiments, the metal powder has a size in the range of from 1 to 300 μm.

In at least some embodiments, the method further comprises, washing the NHC coated metal powder with the alcohol solvent to remove the NHC salts. Preferably, the washing is repeated at least 3 times.

In at least some embodiments, the mixing comprises resonance acoustic mixing (RAM).

In at least some embodiments, the alcohol solvent is provided in a volume to weight ratio with respect to the metal powder of from 5 μL per g to 500 μL per g.

In at least some embodiments, the NHC salt is provided in the mixing such that a weight ratio of the NHC salt to the metal powder is from 1:10 to 1:2000.

In at least some embodiments, the mixing is performed at an acceleration ranging from 20 to 100 G.

In at least some embodiments, the mixing is performed for between 30 mins and 5 hours.

In at least some embodiments, the mixing is performed under immersion in the alcohol solvent. Preferably, the NHC salt is provided in a concentration of 5 to 40 mM. In at least some embodiments, the metal powder is provided in a concentration of from 0.1 to 5 g/mL. In at least some embodiments, the mixing is performed for a duration of 20 to 28 h.

In one aspect, there is provided a method of reducing oxide species at a surface of a metal powder producing a NHC coated metal powder, the method comprising performing the method as defined herein.

In one aspect, there is provided the use of a NHC for protecting a metal powder from oxidation.

In still a further aspect, there is provided a metal powder coated with a NHC layer obtained by the method of the present disclosure. Preferably, the metal powder is free of oxides.

In an additional aspect, there is provided a method of coating a substrate with an oxidation resistant layer, the method comprising performing a thermal spray, a cold spray, or additive manufacturing on the substrate with the NHC coated metal powder of the present disclosure.

Many further features and combinations thereof concerning the present improvements will appear to those skilled in the art following a reading of the instant disclosure.

### DESCRIPTION OF THE DRAWINGS

FIG. 1A is a photograph of the sample holder for resonant acoustic mixing containing 22 vials.

FIG. 1B is a photograph of the sample holder of FIG. 1A with a cover cap.

FIG. 1C is a photograph of the sample holder of FIG. 1A without vials.

FIG. 2 is a Cu 2p X-ray photoelectron spectroscopy (XPS) of copper powder as received from the manufacturer. The dashed area shows the kinetic energy window used to as the control (i.e. before any surface modification).

FIG. 3A is a Cu 2p XPS plot comparing the spectra before and after the RAM method for the NHC immobilization using different solvents (50 μL of methanol, 50 μL of ethanol or no solvent), the mixing conditions were 90G for 1 h and the weight ratio of NHC to Cu used was 1:20.

FIG. 3B is a Cu LMM XPS plot comparing the spectra before and after the RAM method for the NHC immobilization using different solvents (50 μL of methanol, 50 μL of ethanol or no solvent), the mixing conditions were 90G for 1 h and the weight ratio of NHC to Cu used was 1:20.

FIG. 4 is a stacked Cu 2p XPS plot comparing the spectra before and after the RAM method for the NHC immobilization using different NHC:Cu ratios (mixing conditions: 90 G, 1 h. MeOH volume: 50 μL).

FIG. 5 is a stacked Cu 2p XPS plot comparing the spectra before and after the RAM method for the NHC immobilization using different MeOH volumes (50, 250 or 500 μL with mixing conditions: 90 G, 1 h and a weight ratio NHC:Cu=1:1000).

FIG. 6A is a stacked Cu 2p XPS plot comparing the spectra before and after the RAM method for the NHC immobilization using different mixing conditions (90 G for 1 h, 30 G for 1 h, 30 G for 5 h) with a weight ratio NHC:Cu=1:1000 and a methanol volume of 50 μL.

FIG. 6B is a Cu LMM XPS plot comparing the spectra before and after the RAM method for the NHC immobilization using different mixing conditions (90 G for 1 h, 30 G for 1 h, 30 G for 5 h) with a weight ratio NHC:Cu=1:1000 and a methanol volume of 50 μL.

FIG. 7A is a deconvolution of Cu 2p XPS spectra of the copper powder before NHC treatment using the different mixing conditions of FIG. 6A.

FIG. 7B is a deconvolution of Cu 2p XPS spectra of the copper powder after NHC treatment using the different mixing conditions of FIG. 6A.

FIG. 8A is a Cu 2p XPS plot comparing the spectra before and after the RAM method for the NHC immobilization (30 G for 5 h with a weight ratio NHC:Cu=1:1000 and a methanol volume of 50 μL).

FIG. 8B is a Cu LMM XPS plot comparing the spectra before and after the RAM method for the NHC (30 G for 5 h with a weight ratio NHC:Cu=1:1000 and a methanol volume of 50 μL).

FIG. 9 is a matrix-assisted laser desorption ionization (MALDI) spectra before and after the RAM method for the NHC immobilization (30 G for 5 h with a weight ratio NHC:Cu=1:1000 and a methanol volume of 50 μL).

FIG. 10A is a scanning electron microscopy (SEM) of copper powder before the NHC surface modification by the RAM method.

FIG. 10B is a SEM of the copper powder after NHC surface modification by the RAM method (30 G for 5 h with a weight ratio NHC:Cu=1:1000 and a methanol volume of 50 μL).

FIG. 11 is a schematic representation of surface oxide reduction and concurrent formation of a stable coating on Cu powder.

FIG. 12A is a scanning electron microscopy of Cu powder before performing the immersion NHC coating method.

FIG. 12B is a scanning electron microscopy of Cu powder after performing the immersion NHC coating method to obtain coated NHC (labelled NHC—Cu).

FIG. 13A is a graph showing the particle size distribution (PSD) of the Cu powder as received from the manufacturer.

FIG. 13B is a graph showing the PSD of the NHC—Cu powder.

FIG. 14A is a matrix-assisted laser desorption ionization time of flight (MALDI-TOF) mass spectra of uncoated Cu powder.

FIG. 14B is a MALDI-TOF spectra of NHC—Cu powder coated by immersion in 10 mM NHC for 24 h under stirring at ambient conditions.

FIG. 15A is a XPS spectra of uncoated Cu powder.

FIG. 15B is a XPS spectra of NHC—Cu powder.

FIG. 16A is a N1s XPS spectra of uncoated Cu powder and NHC—Cu.

FIG. 16B is a microscopy image showing the deconvoluted spectra of N1s.

FIG. 16C is a Cu2p XPS spectra of uncoated Cu powder and NHC—Cu

FIG. 17 is a bar graph representing % Cu(II) and % Cu(I)+Cu(0) for uncoated powder and for NHC—Cu powder.

FIG. 18A is a MALDI-ToF spectra of NHC—Cu obtain by immersion in 10 mM NHC solution for 24 h duration without stirring.

FIG. 18B is a MALDI-ToF spectra of NHC—Cu obtain by immersion in 10 mM NHC solution for 24 h duration with stirring.

FIG. 19 is a bar graph showing the effect of stirring on % Cu(II) and % Cu(I)+Cu(0).

FIG. 20A is a MALDI spectra of NHC—Cu obtained with the immersion method with 0, 5, 10, 20, 40 mM NHC.

FIG. 20B is a Cu 2p XPS spectra of NHC—Cu obtained with the immersion method with 0, 5, 10, 20, 40 mM NHC.

FIG. 20C is a bar graph showing the Cu (II) % and Cu(I)+Cu(0)% for NHC—Cu obtained with the immersion method with 0, 5, 10, 20, 40 mM NHC.

FIG. 21 is a stacked MALDI-TOF spectra for different immobilization periods (uncoated, 12 h, 24 h, 48 h, or 72 h) Cu powder samples using 10 mM NHC concentration along with stirring.

FIG. 22A is a Cu 2p XPS spectra of NHC—Cu before immersion (ref) or after 12 h, 24 h, 48 h, or 72 h of immersion with 10 mM NHC.

FIG. 22B is a bar graph showing the Cu (II) % and Cu(I)+Cu(0)% for NHC—Cu before immersion (ref) or after 12 h, 24 h, 48 h, or 72 h of immersion with 10 mM NHC.

FIG. 22C is a Cu 2p XPS spectra of NHC—Cu before immersion (ref) or immersion at room temperature, 30° C., 40° C., 50° C., or 60° C. with 10 mM NHC.

FIG. 22D is a bar graph showing the Cu (II) % and Cu(I)+Cu(0)% for NHC—Cu before immersion (ref) or immersion at room temperature, 30° C., 40° C., 50° C., or 60° C. with 10 mM NHC.

FIG. 23 is a stacked MALDI-TOF spectra for different immersion temperatures (uncoated, 30° C., 40° C., 50° C., or 60° C.) using 10 mM NHC concentration along with stirring.

FIG. 24A is a MALDI spectra of a stability test of NHC—Cu samples under oxidation conditions in 0.1 M NaOH solution for 1 h.

FIG. 24B is a MALDI spectra of a stability test of NHC—Cu samples under oxidation conditions in 0.1 M NaOH solution for 5 h.

FIG. 25 is a N 1s XPS spectra of NHC—Cu after a stability test under oxidation conditions in 0.1 M NaOH for 0 h, 1 h or 5 h.

FIG. 26A is a SEM showing a surface of Cu coating at a magnification of ×2000.

FIG. 26B is a close up of FIG. 26A.

FIG. 26C is a SEM showing a surface of Cu—NHC coating at a magnification of ×2000.

FIG. 26D is a close up of FIG. 26C.

FIG. 27A is a SEM showing a cross section of Cu coating.

FIG. 27B is a magnification of FIG. 27A.

FIG. 27C is a SEM showing a cross section of Cu—NHC coating.

FIG. 27D is a magnification of FIG. 27C.

FIG. 28A is a scanning transmission microscopy image of Cu coating.

FIG. 28B is an energy dispersive X-ray spectroscopy (EDS) spectra of the Cu coating of FIG. 28A.

FIG. 28C is a scanning transmission microscopy image of C—NHC coating.

FIG. 28D is an EDS spectra of the Cu—NHC coating of FIG. 28A.

FIG. 29 is a graph showing electrochemical impedance spectroscopy (EIS) measurements performed for both Cu—NHC and Cu surface under the same conditions.

FIG. 30A is a scanning electron microscopic image of a cross sections of Cu—NHC coating.

FIG. 30B is a scanning electron microscopic image of a cross sections of bare Cu coating.

FIG. 31A is a MALDI spectra of aluminum powder without NHC coating (reference), with iPr-NHC treatment and with Meso-NHC treatment.

FIG. 31B is a MALDI spectra of titanium powder without NHC coating (reference), with iPr-NHC treatment and with Meso-NHC treatment.

### DETAILED DESCRIPTION

N-heterocyclic carbenes (NHCs) have the ability to form stable self-assembled layers on copper surfaces. Unlike other materials, NHC has the additional advantage of removing oxides from the copper surface during or prior to the formation of a stable coating. The formation of a NHC coating thereby reduces further oxidation of the copper surface. NHCs are a commercially available reagent. Thiol-based analogues of NHCs have been studied for their capability to remove surface oxide and for the formation of a self-assembled layer (SAL) on copper surfaces. However, thiol-based analogs of SAL are not stable under ambient conditions, and in organic solvents such as tetrahydrofuran, thus greatly limiting their applications for ambient and solvent conditions. Contrarily, NHC-based SALs are stable alternatives to thiol-based SALs and thus have the advantage of being useful in many industries that require metal powder such as Cu powder at ambient conditions.

The term metal powder as used herein refers to a micron range powder which can be characterized by a size of from 1 to 300 μm, from 1 to 200 μm, from 1 to 100 μm or from 1 to 50 μm. In some embodiments, the metal powder is characterized by a D50 of from 5 to 200 μm and optionally a D90 of from 20 to 300 μm. In some embodiments, the particle size can be measured by performing a scanning electron microscopy (SEM) on the metal powder and then measuring the size (e.g. diameter) of the particles with an appropriate analysis program (e.g. Spraytec—Wet Cell from Malvern Panalytical®). The term “metal” as used herein is defined, in some embodiments, as being selected from Cu, Ti, Ni, Al and, Fe and their alloys.

Accordingly, there is provided a method of producing a N-heterocyclic carbene (NHC) coated metal powder by mixing an alcohol solvent such as methanol, metal powder and a N-heterocyclic carbene (NHC) salt to obtain a NHC coated metal powder. The NHC coated metal powder may subsequently be separated from the alcohol solvent by physical means such as settling, decantation, filtration, evaporation and the like. The term “alcohol solvent” as used herein can be defined as being a solvent selected from methanol, ethanol, butanol or propanol. The method is preferably conducted under ambient conditions such as a room temperature of 18 to 25° C. or 20 to 25° C. and atmospheric pressure (1 atm±3%). The obtained NHC coated metal powder is preferably washed with the alcohol solvent for at least one wash cycle, preferably at least three. The NHC coated metal powder can then be dried under vacuum. The size of the NHC coated metal powder is substantially the same as that of the metal powder at the microscopic scale although a SAL layer of NHC coats the metal powder. Accordingly, the NHC coated metal powder can be characterized by a size of from 1 to 300 μm. In some embodiments, the NHC coated metal is characterized by a D50 of from 5 to 200 μm and optionally a D90 of from 20 to 300 μm.

The term N-heterocyclic carbene salts as used herein can be any of the N-heterocyclic carbene salts described in U.S. Ser. No. 11/008,291, the contents of which are hereby incorporated by reference in their entirety. The N-heterocyclic carbene salts are preferably carbonate salts. In one embodiment, the N-heterocyclic carbene salt is:

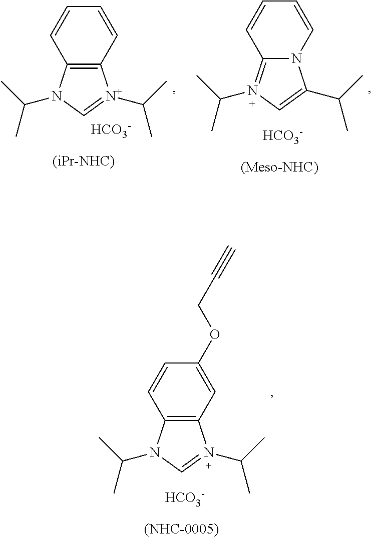

and combinations thereof.

The present disclosure provides two methods of performing the mixing of the metal powder, NHC carbene salt and the alcohol solvent. An immersion method and a mechanochemical approach. In the immersion method, the metal powder and the NHC carbene are immersed in an alcohol solvent and a mechanochemistry method where the volume of solvent is minimal and the components are mixed via RAM. Proper mixing is needed when coating a metal powder to sufficiently and uniformly coat all the surfaces of each particle of the metal powder.

The immersion method is performed by mixing under immersion in an alcohol such as methanol, the NHC salt and the metal powder. Preferably, the concentration of NHC salt is in the range of from 5 to 40 mM, from 5 to 20 mM, from 5 to 15 mM, from 7 to 13 mM, from 8 to 12 mM or about 10 mM. Preferably, the concentration of metal powder is provided in a concentration of about 1 g/mL in alcohol, for example from 0.1 to 5 g/mL, from 0.2 to 4 g/mL, or from 0.5 to 2 g/mL. The mixing is performed for a duration that is sufficient for sufficiently coating the copper surfaces, for example at least 20 h, at least 22 h, at least 24 h, from 20 to 28 h, or from 22 to 26 h.

The mechanochemical approach is performed with resonant acoustic mixing, which is a mixing technique for non-bulk-solvent processes. The advantage of the mechanochemical approach is that it utilizes less solvent and is therefore more economical and more environmentally friendly (green chemistry). Compared to immersion or electrodeposition methods, RAM is easy to scale up for industrial needs. It works on a different principle and offers advantages over traditional mechanochemical methods, such as ball-milling, grinding and extrusion. RAM provides a low-energy contactless mixing system by vibrating a sample vessel on a spring bed at a resonant frequency to introduce intense local mixing zone for sample particles, mitigating damage and avoiding contamination. It has been employed to prepare cocrystals, blend pharmaceutical powders and synthesize organic molecules. However, the mechanism of mechanochemical reactions remains unclear. Despite the addition of a small amount of solvent which was believed to enhance molecular mobility, dry mixing was also reported to facilitate mechanical reactions. In the present method, a limited amount of solvent was added, and several parameters were optimized to achieve the NHC deposition on copper powders.

More specifically, the RAM can be operated at a suitable frequency (for example from 20 to 100 Hz, from 40 to 80 Hz or from 50 to 70 Hz). The alcohol, preferably methanol, is provided in a volume to weight ratio, with respect to the weight of the metal powder, of from 5 μL per g to 500 μL per g of the metal powder. In some embodiments, the ratio is from 10 to 250 μL per g, from 15 to 200 μL per g, or from 20 to 150 μL per g. The NHC is provided in a weight ratio of NHC:metal powder of from 1:10 to 1:2000, 1:20 to 1:2000, 1:50 to 1:2000, 1:100 to 1:2000, 1:10 to 1:1500 or about 1:1000 where about is defined as ±5%. The acceleration and the duration of the mixing can be varied and they depend on each other. In general, the acceleration can be from 20 to 100 G, or from 30 to 90G, and the duration can be from 30 mins to 7 h, from 45 mins to 6 h, or from 1 h to 5 h.

### Example 1: N-Heterocyclic Carbenes Deposition on Copper Powder Surface Using Mechanochemistry

The copper powder (spheroidal), 10-25 μm, 98% purity, used in the present example was purchased from Sigma-Aldrich™. The methanol (high-performance liquid chromatography (HPLC) grade) and the ethanol anhydrous were acquired from Fisher Chemical™ and Commercial Alcohols™, respectively. The NHC precursor used was iPr-NHC, which is the compound 1,3-diisopropylbenzimidazolium hydrogen carbonate (iPr_NHC) and is of the formula as shown below. The iPr-NHC was synthesized by Queens University and used as received. All solvents were used without any further purification.

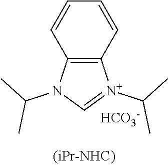

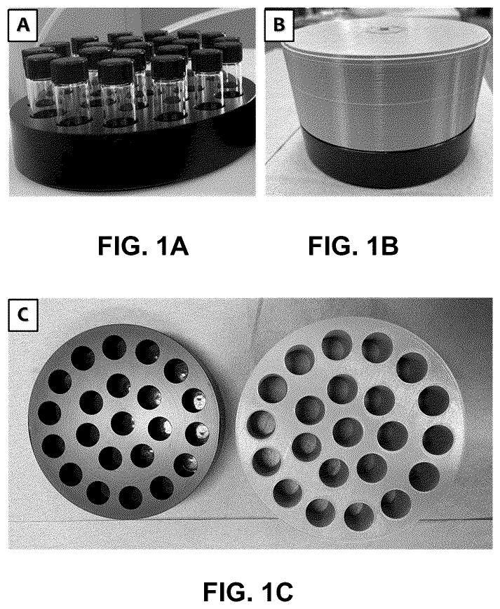

The NHC immobilization on the copper powder was performed using a Resonant Acoustic Mixer (RAM) (LabRAM II, Resodyn™), with a sample holder featuring twenty-two 5 mL vials and a 3D printed cap (FIGS. 1A-1C). During the mixing process, 5 mL glass vials with plastic caps were used to contain the mass. The basic composition of the mass was copper powder, NHC and solvent. The copper powder weight was kept fixed at 2 g while the other parameters such as sample composition and mixing conditions were evaluated individually. Table 1 shows the parameters for sample composition and mixing conditions evaluated in the present example. The reported sample consisted of copper powder (2 g), NHC (20 mg) and methanol (50 μL), and it was mixed for 5 hours at 30 G.

TABLE 1
Parameters for sample composition
and mixing conditions evaluated
Sample Composition

| | |
|---|---|
| Solvent | Methanol (MeOH), ethanol (EtOH), |
| | no solvent (None) |
| Solvent volume | 50 μL, 250 μL, or 500 μL |
| NHC:Cu ratio (w/w) | 1:20, 1:100, or 1:1000 |

Mixing Condition

| | |
|---|---|
| Acceleration | 30 G, or 90 G. |
| Time | 1 h, or 5 h. |

The ingredients were weighed directly into the vessel at the beginning of each mixing cycle. Based on the fact that the Cu powder consistently occupied the largest volume within the vessel, it can be concluded that the fill level remained below 20% in all cases.

After mixing, the Cu powder was washed using 3 mL of the solvent that was used during the reaction (methanol or ethanol) to remove the NHC excess. The washing was specifically performed by adding 3 mL of solvent inside the vial, shaking the vial for a few seconds and then letting the vial sit on the bench. After the powder decantation, the supernatant solvent was removed using a Pasteur pipette, and the procedure was repeated 5 times. Lastly the powder was vacuum dried in a desiccator for around 10 h.

The starting point was to identify a proper solvent for the NHC immobilization procedure. Thus, in the first round of experiments MeOH, EtOH and no solvent were the conditions tested. The NHC:Cu ratio and the solvent volume of each sample was 1:20 and 50 μL, respectively, and mixing was performed at 90 G acceleration for 1 h.

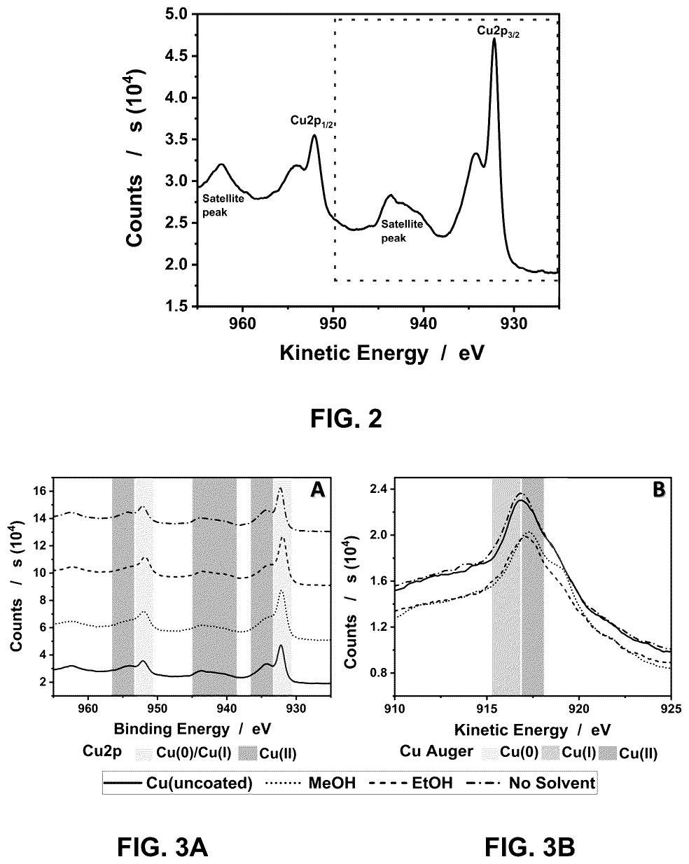

All the characterization analysis methods were performed using Cu powder samples after the washing and drying procedures described herein. The X-ray photoelectron spectrometry (XPS) measurements were performed using K-Alpha X-ray XPS System from Thermo Scientific™. Survey spectra were collected, along with high-resolution element scans such as Cu2p, Cu LMM, C, O and N. The C 1s peak at 284.8 eV was used as a reference to calibrate the high-resolution spectra. FIG. 2 presents a Cu 2p XPS sprectra obtained from the copper powder as received.

The XPS spectra was obtained before and after NHC immobilization revealed differences between shake-up peaks at 943.5 eV binding energy (FIG. 3A). An increase in the Cu 2p_{3/2} peaks was also observed. In both cases, the differences are more significant on the sample where MeOH was used. Without solvent the NHC treatment was not effective.

The Cu LMM XPS plot (i.e. Cu Coster-Kronig transition of the type LMM) was also evaluated in order to get more qualitative information on the copper species present on the surface of the sample. On FIG. 3B the plot highlights the characteristic regions for the Cu(II), Cu(I), and Cu(0) species respectively. The composition of the sample mixed without solvent is very similar to the sample before the treatment. When EtOH and MeOH were used, a shift in the peak was observed, indicating that these samples probably have less Cu⁺ in their surface. However, only for the MeOH sample a second peak is noticed in the Cu⁰ region, which demonstrates the significant increasing of this specie on the sample.

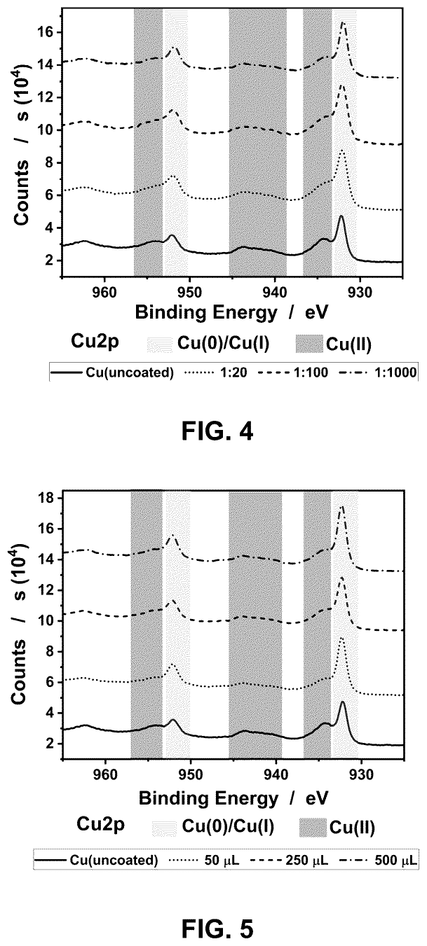

MeOH showed a better performance when compared to the other sample conditions, and for that reason MeOH was chosen as the solvent for the NHC treatment. The next step was to evaluate the NHC amount that needs to be included in the mixture. Therefore, three different weight ratios of NHC:Cu were tested (see Table 1). The results were evaluated through XPS measurements and are presented in FIG. 4. As can be seen from FIG. 4, even when decreasing the NHC concentration significantly the treatment was still very effective in reducing the oxide layer. This indicates that NHC was in huge excess initially. A careful observation can reveal that the sample treated with lowest concentration of NHC had the smaller intensity on the shake-up peaks, i.e., less Cu²⁺. Based on this observation, and based on the fact that using less NHC could be advantageous, the NHC:Cu ratio of 1:1000 was selected for further experiments.

The last sample condition evaluated was the amount of solvent (three different volumes were used 50 μL, 250 μL, or 500 μL see Table 1). The results showed that this parameter also had a low impact on the NHC efficiency (FIG. 5). All the after-treatment samples exhibited Cu 2p_{3/2} peaks more intense and lower shake-up peaks when compared with the sample before treatment. Although the results were very similar, in the sample where the smallest amount of solvent was used, showed the lowest intensity on the shake-up peaks. Therefore, the 50 μL volume of MeOH was selected.

Based on the above experiments, it was determined that the optimal composition for the sample is a weight ratio of 1:1000 (NHC:Cu) and 50 μL of MeOH. This was used for the subsequent experiments.

RAM is an advanced mixing technology that operates in a low-frequency and high-intensity acoustic field to facilitate the movement of loose powder, inducing to an efficient mixing. Operating at a fixed frequency (around 60 Hz), the LabRAM™ II basically receives the input of two parameters on the method recipe: time and acceleration. In this work, the vessel fill level was kept fixed at 20%. However this parameter has a low influence on the mixing performance which can be considered negligible.

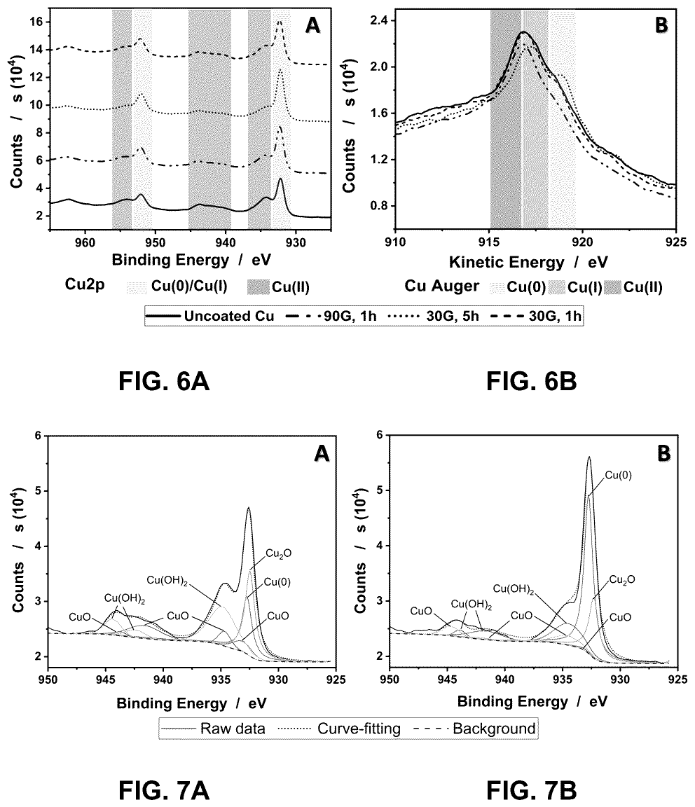

Hence, with the frequency and fill level fixed, the acceleration and time were assorted to find a best combination of these two parameters. Three specific conditions were performed (90 G for 1 h, 30 G for 1 h and 30 G for 5 h) and FIGS. 6A-6B show the results. With the highest acceleration (90G), a good result is observed (FIG. 6A). However, almost no shake-up peaks are observed when the acceleration is lower (30G), and the mix was performed for a longer time (5 h). In addition, the Auger spectra (FIG. 6B) for the condition of mixing of 30G for 5 h clearly shows a second peak in the Cu⁰ region (FIGS. 7A-7B).

Considering all the observations aforementioned, it was determined that the optimal condition for NHC deposition onto copper powder was achieved by employing an acceleration of 30G for 5 hours. These mixing conditions were used for the subsequent experiments.

Removal of Cu oxide (CuO) was evaluated using XPS measurements. The high-resolution XPS spectrum of Cu 2p presents two main peaks assigned to Cu 2p_{1/2} and Cu 2p_{3/2} at 952.2 and 932.1 eV respectively, with two satellite peaks located at 962.3 and 943.5 to 940.6 eV. The satellite peaks are seen when excess electrons are excited to higher energy states. The presence of multiple peaks demonstrates the presence of copper in different oxidation states, such as Cu oxides (Cu²⁺ and Cu⁺) and Cu metallic (Cu⁰).

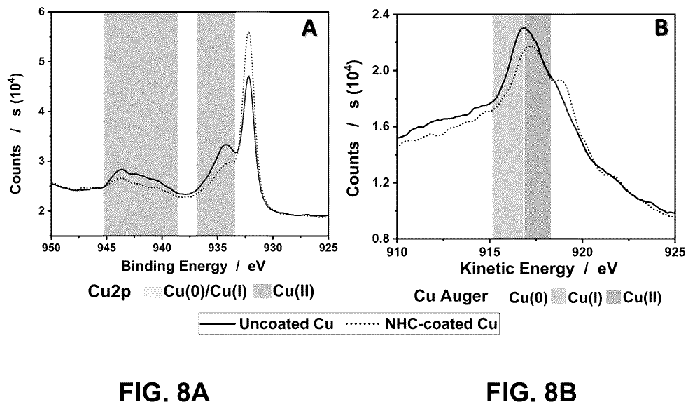

FIG. 8A presents the comparative findings of XPS measurements, both pre- and post-NHC treatment. The result showed a significant decrease in the peak at 934.2 eV and the satellite peak, which are regions expected to be Cu²⁺ surface. This is strong evidence that the NHC treatment chemically removed oxides from copper surface. The increase in the 932.4 eV peak can also contribute to those conclusions. However, only from Cu 2p spectra is it possible to soundly conclude that the make-up of the resulting surface chemical state since the signals for Cu⁺ and Cu⁰ overlap in XPS.

Performing a Cu LMM analysis is essential for performing a chemical characterization of a copper surface. Cu LMM provides valuable insights into the composition and bonding properties of the copper surface. The peaks of Cu LMM reveal distinctive energy levels associated with core-level electron transitions, enabling precise identification of surface elements and their chemical states. On FIG. 8B the plot highlights the characteristic regions for the Cu(II), Cu(I), and Cu(0) species. A shifting in the spectra was observed in the measurement performed after NHC treatment which means that the chemical composition changed in the sample. However, the most import observation is the emergence of a second peak in the Cu⁰ region, confirming the enhancement of the metallic specie after NHC treatment.

These findings demonstrate that the RAM technique holds great promise for the deposition of NHC onto powders. By implementing the described procedure, a substantial transformation in the surface chemistry of copper powder was achieved, characterized by a noteworthy oxide removal and increase of Cu⁰ species. These changes have significant benefits for industrial applications, including faster and more sustainable processes. By significantly reducing the need for extensive solvent use, the RAM technique aligns with sustainable practices, positioning the mechanochemical approach of the present example as an environmentally friendly option.

Besides the impressive ability of etching chemically the oxide layer of the Cu powder, the NHC molecule can also bind onto metallic surfaces producing a SAL. It has been demonstrated that those films can be acquired by immersing the metal in an NHC solution for 24 to 48 hours. SALs are a form of nanostructured material and are powerful tools for protection and functionalization of metal surfaces. Hence, it is of interest to demonstrate that the RAM method can also provide the NHC attachment to the Cu surface in a much faster way.

Matrix-assisted laser desorption ionization time of flight (MALDI-TOF) mass spectra were collected on a Bruker™ MALDI Autoflex III TOF mass spectrometer in the reflector mode and potassium trifluoroacetate (CF₃CO₂K) was added as a cation source and dithranol (DIT) was used as matrices.

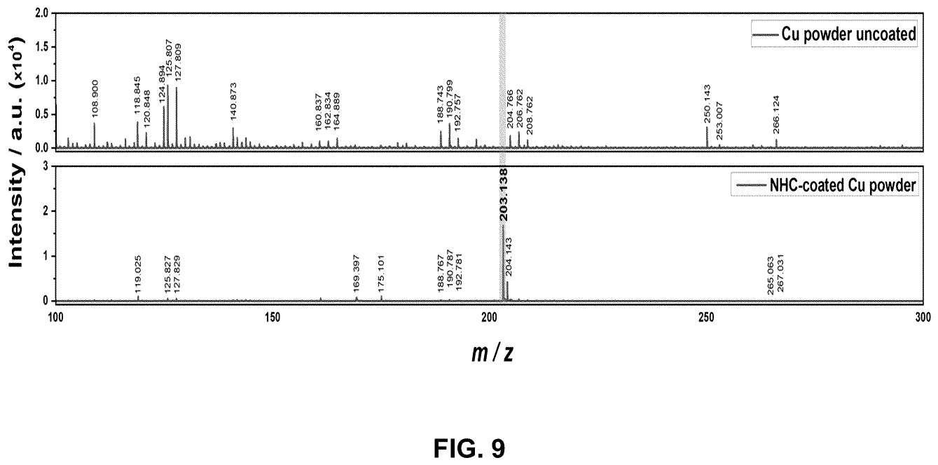

MALDI spectra were collected before and after the NHC treatment and FIG. 9 presents the results. By comparing both spectra, the presence of a peak around 203 m/z on the sample treated with NHC was identified which corresponds to the iPr-NHC. That peak is absent in the uncoated sample spectra. That observation is strong evidence that NHC, even after powder successive washing, was able to maintain attached to the Cu powder surface.

When considering industrial applications, different characteristics of the Cu powder, such as particle shape, size, oxide content, surface roughness, etc. are relevant in different industries. It is important that the surface treatment maintains as much as possible these characteristics since they can impact directly the efficiency and performance of industrial processes using the Cu powder (e.g. thermal spray). As demonstrated in Example 3, the coated powder of the present disclosure is suited for thermal spray applications. Accordingly, it is also important that the characteristics remain consistent throughout the surface modification method described herein. In general, the RAM method is more likely to affect the shape and size of particles, therefore these two characteristics were investigated.

There are alternatives to thermal spraying and thermal spraying is only provided as one example of an application method. Alternatives include cold spraying, additive manufacturing and powder metallurgy techniques.

The morphological characterization was performed using the scanning electron microscopy (SEM) and the particle size distribution (PSD) techniques. Hence, the SEM images were obtained using a FEI ESEM Quanta 450 FEG from FELMI-ZFE™, magnitude 500×, 10 kV high voltage, spot size 2.5 and ETD-SE detector. The PSD was measured using Spraytec—Wet Cell from Malvern Panalytical™, liquid mode, from a dispersion of 1 g from Cu powder in 20 mL of water.

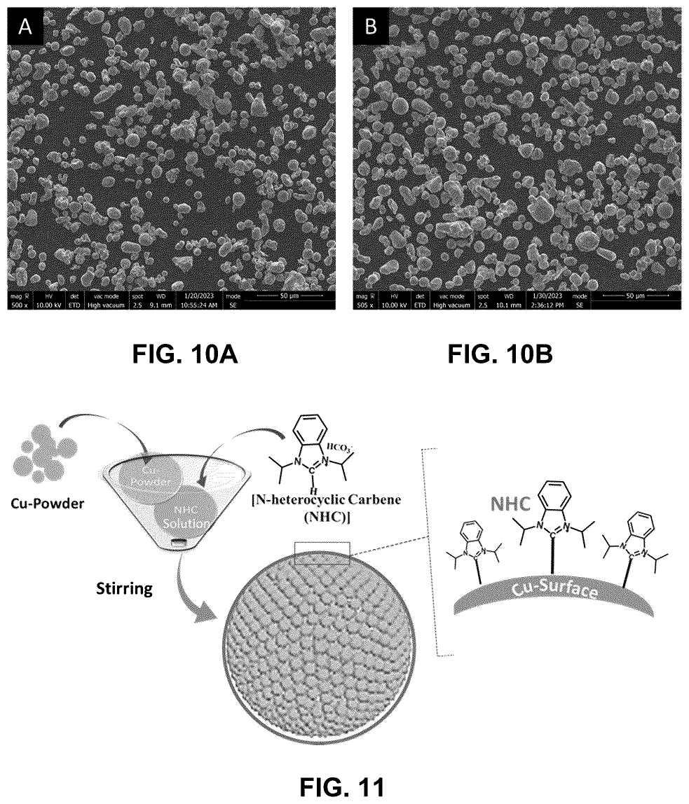

SEM was used to evaluate the Cu powder shape and FIGS. 10A-10B present the images recorded before and after the RAM mixing. The resonant acoustic mixing procedure did not impact the morphology of the Cu powder particles, neither on the highest acceleration (90 G) or when mixing for 5 h at 30G. In all cases, the particles had a similar slightly irregular and spherical shape.

The particle size was analyzed using PSD analysis and Table 2 provides the results for the D50 and D90 of the samples. Mixing for a longer time seemed to have a greater impact in the PSD of the Cu powder when compared with the sample before mixing. However, it is important to mention that this difference was not significant as it did not even make up 10% of the total.

TABLE 2
PSD analysis on Cu powders before and
after RAM mixing for NHC immobilization

| Mixing condition | D50 (μm) | D90 (μm) |
|---|---|---|
| Uncoated Cu powder | 12.09 | 22.99 |
| Powder after agitation for 5 h at 30 G | 10 (±1) | 21 (±2) |

The RAM method was thus shown to be a safe approach for NHC immobilization in terms of preserving particle morphology. It was confirmed that neither the Cu powder particle size nor its shape were substantially affected during the RAM coating method.

In conclusion, in the present example, a method for the NHC immobilization on Cu powder samples using mechanochemistry was achieved. The described method included the usage of the resonant acoustic mixer, an advanced and promising technique used for the NHC coating of Cu powders that, under the tested experimental conditions, kept the particles undamaged. XPS results demonstrated a significant decrease in Cu²⁺ on the NHC treated samples. The presence of NHC in the samples after the treatment was verified by the presence of the 203 (m/z) peak in MALDI spectra. The optimal experiment conditions for the NHC deposition was found to be the ratio of 1:1000 (NHC:Cu) and 50 μL of MeOH, mixed at 30G for 5 h. These studies are critical to demonstrate that mechanochemistry can be applied in the NHCs immobilization, posing a much more sustainable approach to mitigate corrosion.

### Example 2: Surface Oxide Removal from Cu Powder Using N-Heterocyclic Carbene for Thermal Spray Applications

In the present example, a surface oxide reduction was performed by coating NHC on the Cu powder using an immersion method developed (FIG. 11). The process forms a self-assembling layer (SAL) of NHCs on the Cu powder surface which simultaneously leads to the reduction of the surface copper oxide and provides a NHC coating that is resistant to oxidation.

Copper (Cu) powder was procured from Sigma Aldrich™ (Canada) with a purity of 99.0%. High performance liquid chromatography (HPLC) grade methanol was obtained from Fischer Chemical™ (Canada) and used without any further purification. The 1,3-diisopropylbenzimidazolium hydrogen carbonate (NHCs) was synthesized using a previously reported procedure (Crudden, C., Horton, J., Narouz, M. et al. Simple direct formation of self-assembled N-heterocyclic carbene monolayers on gold and their application in biosensing. Nat Commun 7, 12654 (2016)). Briefly, 1,3-diisoproplylbenzimidazolium iodide was dissolved in methanol and mixed with a prepared hydrogen carbonate exchange resin. The mixture was passed through a cotton plug to remove any resin beads. Solution was evaporated and the residual solid was sonicated in acetone and decanted off. The left white powder after drying under vacuum is the 1,3-diisopropyl benzimidazolium hydrogen carbonate.

Immobilization of NHCs on Cu powder was achieved by adopting a green approach, the immersion method. An amount of Cu powder (0.132 g) was placed in a conical flask to which a NHC solution (5, 10, 20 or 40 mM) is added. The NHC solution (iPr-NHC) was prepared in methanol while stirring. The mixture was allowed to react under stirring followed by removing it from the stirrer to allow the settling of Cu powder at the bottom of the flask. The settled powder was washed multiple times with methanol to remove the unreacted and physically adsorbed NHCs followed by drying the powder under argon flow and thereafter storing the powder in a desiccator connected to the vacuum. It is noteworthy to mention that NHC is highly sensitive to both moisture and environmental oxygen and therefore its handling is crucial before and after each measurement since it should be kept away from both as much as possible. The conditions tested are presented in Table 3.

TABLE 3
Parameters of the immersion method

| | |
|---|---|
| Concentration of NHC solution (mM) | 5, 10, 20, or 40 |
| Time of immobilization (h) | 12, 24, 48, or 72 |
| Temperature during immobilization (° C.) | RT, 30, 40, 50, or 60 |

Cu powder was immersed in a 10 mM NHC methanol solution under stirring at RT, which upon retrieval was tested for the presence of NHC-coating (represented as NHC—Cu). The presence of coating and surface oxide removal in NHC—Cu was fully characterized by various microscopic and spectroscopic measurements such as SEM, MALDI, and XPS techniques. This simple and straightforward methodology is highly suitable for functionalizing and removing the surface oxide on a highly sensitive surface like Cu.

The investigation of the NHC—Cu sample resulting from immersion methodology was initially performed using scanning electron microscopy (SEM) measurements. Specifically, the morphology of each variant (before and after coating) was analyzed using field emission electron microscopy (FE-SEM) from Hitachi Regulus™ 8230. The particle size distribution (PSD) was determined using the Spraytec-Wet™ cell from Malvern™ Panalytical using a known concentration dispersed in water.

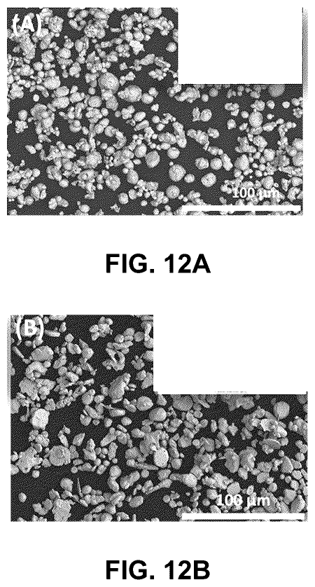

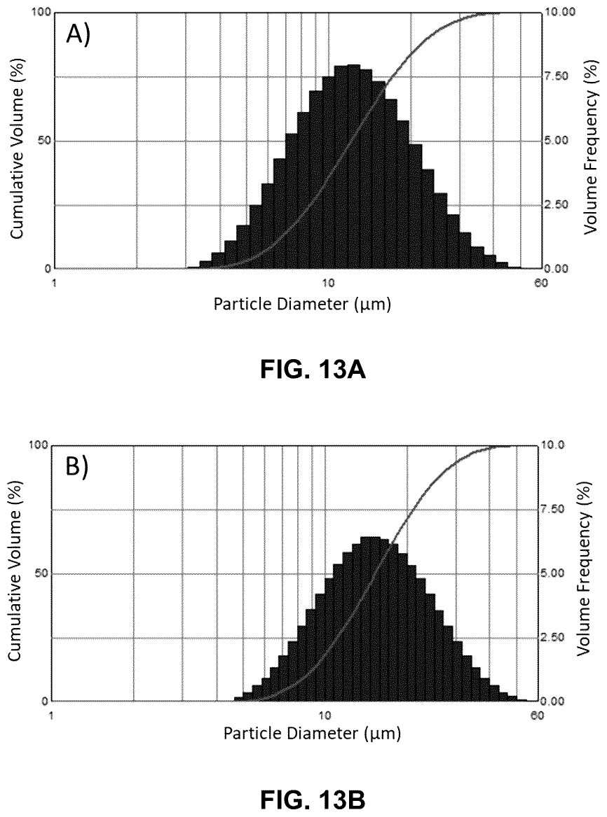

The idea was to examine any morphological changes in the Cu powder resulting from the NHC immersion treatment considering the importance of preserving the morphology of Cu powder for thermal applications. As shown in FIGS. 12A-12B, no significant change was observed at the macroscopic scale, and all the particles appeared to have a spheroidal morphology. Importantly, no significant disintegration or agglomeration of Cu particles was observed when comparing NHC—Cu to the as-received Cu powder. A detailed investigation was performed using the particle size distribution (PSD) analysis and Dv(50) values for uncoated Cu and NHC—Cu powder samples were determined to be 12.09 μm and 15.24 μm respectively indicating only slight changes (Table 4 and FIGS. 13A-13B).

TABLE 4
Comparison of particle size distribution of uncoated
and NHC-Cu powder along with stirring

| PSD parameters | Uncoated Cu powder | NHC-Cu powder |
|---|---|---|
| Dv(10) (μm) | 6.362 | 8.479 |
| Dv(50) (μm) | 12.09 | 15.24 |
| Dv(90) (μm) | 22.99 | 27.43 |

Confirmation of the NHC coating on Cu powder (NHC—Cu surfaces) was performed by two measurements, namely, mass spectroscopy via matrix-assisted laser desorption/ionization-time of flight (MALDI-ToF) and X-ray photoelectron spectroscopy (XPS).

The XPS measurements were performed using a monochromatic Al-Kα X-ray source (hv=1486.6 eV) from Thermo Scientific™ under ultra-high vacuum (UHV) conditions. The operating pressure of the instrument was 9×10⁻⁸ mbar. Depending on the sample, both survey spectra and high-resolution spectra were collected at a pass energy of 200 eV and 20 eV respectively. The charge correction calibration was done for high-resolution spectra using C 1s peak at 284.8 eV as a reference.

To confirm the presence of NHC on the coated sample, matrix-assisted laser desorption ionization-time of flight (MALDI-TOF) techniques were used. The instrument was Bruker™ MALDI Autoflex III TOF mass spectrometer in the reflector mode and potassium trifluoroacetate (CF₃CO₂K) was added as a cation source and dithranol (DIT) was used as matrices.

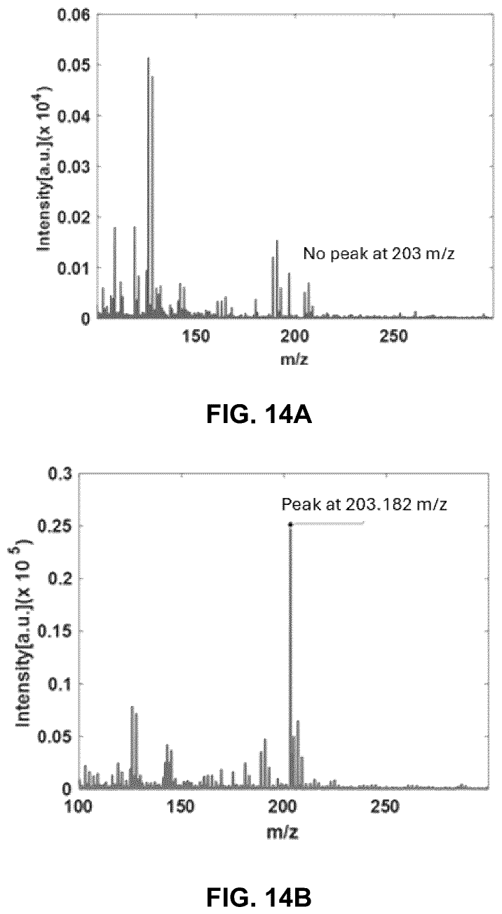

The MALDI-ToF analysis was chosen to selectively probe any NHCs species due to its ionization from the surface, and XPS was chosen to probe for the presence of N1s species together with obtaining information on the reduction of copper oxide from the surface due to NHC coating. MALDI measurements showed the presence of [NHC]⁺ species at the m/z ratio of 203 as an intense peak when the laser is bombarded on the NHC—Cu surface (NHC—[NHC]⁺) but no such peak was evidenced in the uncoated Cu sample (Cu powder) as can be seen in FIGS. 14A-14B. These comparative measurements demonstrate a successful coating of NHC on Cu powder when placed under immersion conditions, similar to the mechanochemical deposition.

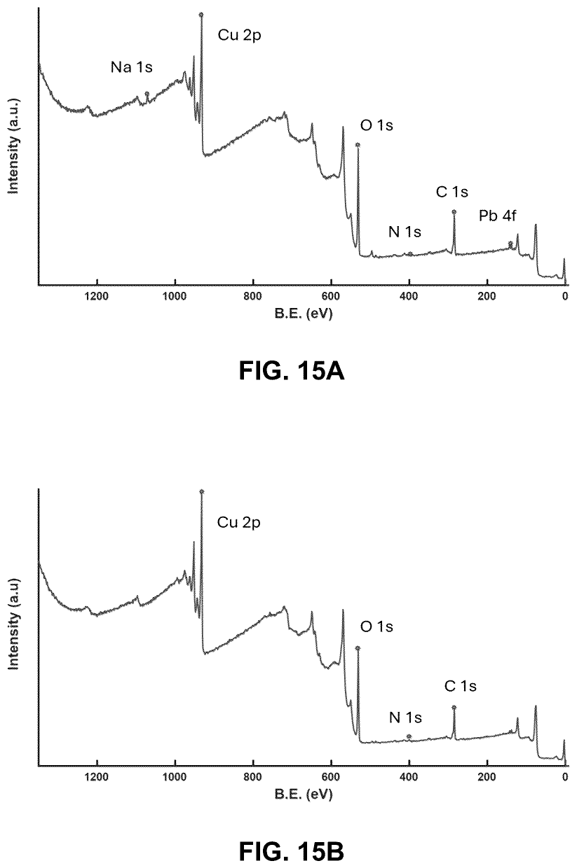

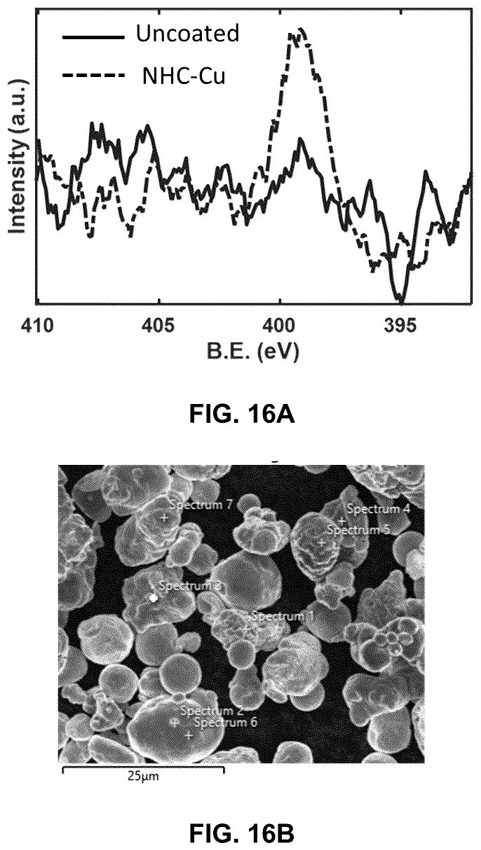

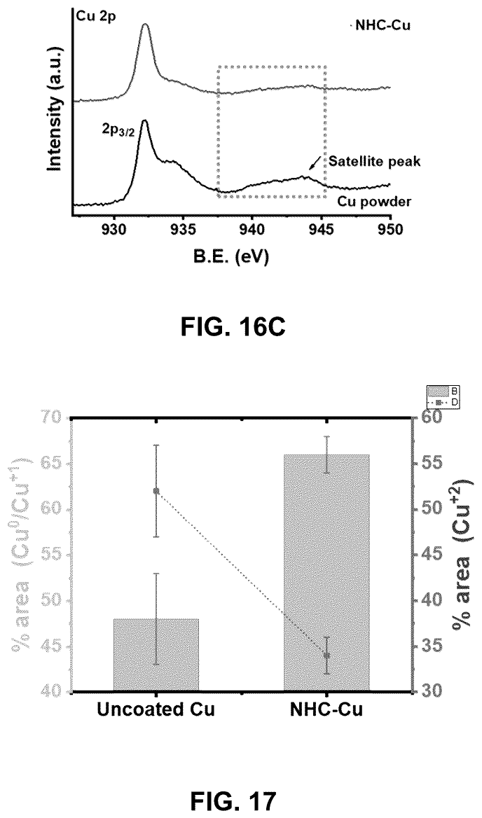

Quantitative insight into the surface oxide removal and the formation of SAL in NHC—Cu surfaces was performed by XPS measurements both before and after NHC treatment. Initially, XPS survey spectra were acquired for uncoated copper and NHC—Cu powder samples see FIG. 15A (O 1s 41.08%, C 1s 41.7%, N 1s 0.02%, Pb 4f 0.22, Na 1s 1.38%) and FIG. 15B (O 1s 41.0%, C 1s 39.0%, N 1s 1.43%). All expected elements were present in the as-received copper sample confirming its purity except for a trace amount of Na and Pb impurities. In the NHC—Cu sample survey, only desirable elements were present such as Cu, C, O, and N and, no peaks were present for impurities, which confirms the high purity of the formed NHC—Cu surfaces, and this information is well supported by the energy dispersive spectroscopy (EDS) results (see Tables 5 and 6). On the NHC—Cu surface, the atomic ratio of O:C:N was 41:39:1.43 versus 41:41:0.02 for uncoated Cu powder. The first observation was only a negligible change in the O:C ratio whereas, a predominant change in the N content was observed after the NHC treatment. These observations indirectly confirm that NHC is present on the NHC—Cu surfaces. Further, to quantify the removal of surface oxide and show the presence of NHC on NHC—Cu surfaces, high-resolution spectra for N 1s and Cu 2p were collected. The N 1s spectra is shown in FIG. 16A and FIG. 16B, SI where a small peak could be visualized at a binding energy of 400 eV in the uncoated sample, which is attributed to the effect of environmental N₂ interference, however, this peak becomes more prominent for the NHC—Cu surfaces. Additionally, the shape of the N1s spectra is a bit different from the uncoated surface, again evidenced by the presence of NHC on Cu powder after immersion. This confirms that NHC is present in the coated sample. Further, the Cu 2p spectra for Cu powder (see FIG. 16C) show the characteristic features having two main peaks at a binding energy of 933.5 eV and 953.6 eV, which are attributed to Cu2p_{3/2} and Cu2p_{1/2} with an intensity ratio of 2:1. Additionally, satellite peaks between binding energy of 938 eV and 946 eV were also observed confirming the presence of oxide in the Cu powder. The same characteristic features were also seen for the NHC—Cu surfaces, but the satellite peaks were suppressed due to the reduction of surface oxide resulting from the NHC treatment. Therefore, the deconvoluted N 1s spectra and the loss of shake-up peaks for Cu(II) for NHC—Cu versus Cu-powder confirms the successful coating of NHC on the Cu powder by the NHC treatment.

TABLE 5
EDS compositional data for NHC-Cu

| Spectrum | | | | | | | | |
|---|---|---|---|---|---|---|---|---|
| Label | 1 | 2 | 3 | 4 | 5 | 6 | 7 | 8 |
| C | 21.10 | 16.43 | 11.34 | 30.85 | 31.92 | 69.02 | 26.69 | 21.40 |
| N | 0.00 | 0.00 | 0.41 | 0.00 | 0.26 | 0.00 | 0.02 | 0.71 |
| O | 1.54 | 26.08 | 1.96 | 2.10 | 2.36 | 7.08 | 0.97 | 6.23 |
| Al | 0.56 | 0.56 | 0.50 | 0.91 | 0.84 | 1.98 | 1.40 | 0.25 |
| Cu | 76.80 | 56.93 | 85.79 | 66.14 | 64.62 | 21.93 | 70.92 | 71.42 |
| Total | 100.00 | 100.00 | 100.00 | 100.00 | 100.00 | 100.00 | 100.00 | 100.00 |

TABLE 6
EDS compositional data for Uncoated Cu

| Spec- | | | | | | | |
|---|---|---|---|---|---|---|---|
| trum | | | | | | | |
| Label | 1 | 2 | 3 | 4 | 5 | 6 | 7 |
| C | 29.36 | 12.58 | 26.91 | 30.27 | 16.75 | 25.61 | 23.58 |
| N | 0.00 | 0.29 | 0.00 | 0.05 | 0.00 | 0.00 | 0.00 |
| O | 3.89 | 0.59 | 3.90 | 2.49 | 1.54 | 2.32 | 1.11 |
| Al | 0.28 | 1.13 | 2.08 | 0.19 | 0.56 | 0.51 | 0.57 |
| Cu | 66.46 | 85.41 | 67.10 | 67.00 | 81.14 | 71.55 | 74.74 |
| Total | 100.00 | 100.00 | 100.00 | 100.00 | 100.00 | 100.00 | 100.00 |

The quantification of the percentage of loss in shakeup peak for Cu 2p spectra for both NHC—Cu surfaces and uncoated Cu powder was analyzed after peak fitting and evaluating the area under the curve. The main emission line of Cu2p_{3/2} around 933.5 eV has contributions from Cu(0), Cu(I), and Cu(II) whereas the shake-up peak ranging between 938 eV and 946 eV has contributions only from Cu(II). Using these specifications, the amount of Cu(II) present and a combined Cu(0)+Cu(I) was calculated using the formulas (1) and (2) below:

$$\% ( Cu ( 0 ) + Cu ( I ) ) = ( A - ( {A}_{1 s} / {B}_{s} ) B ) / ( A + B ) * 100 \qquad ( 1 )$$

$$\% Cu ( II ) = B ( 1 + ( {A}_{1 s} / {B}_{s} ) ) / ( A + B ) * 100 \qquad ( 2 )$$

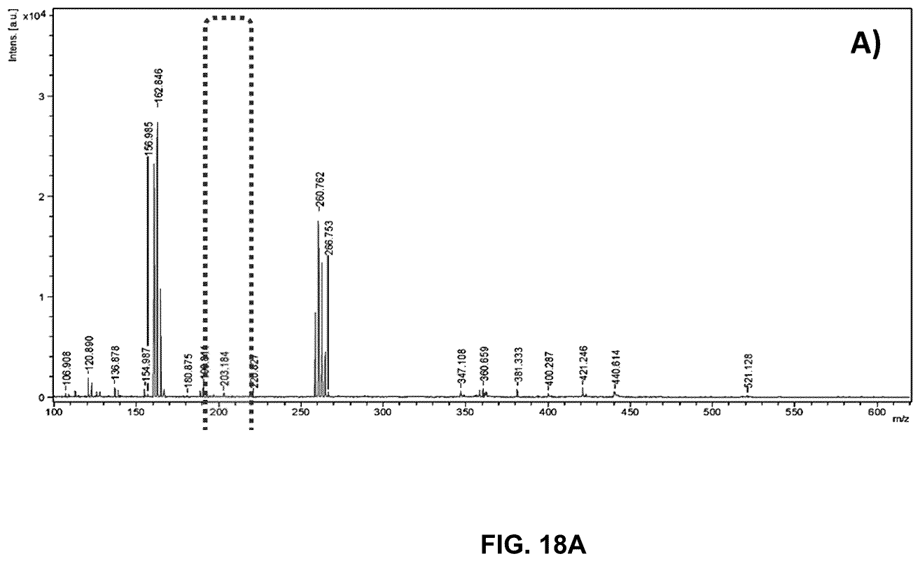

Here ‘A’ is the total area of the main peak, ‘B’ is the total area of the shakeup peak, and ‘A1s/Bs’ is the ratio of the main peak/shake-up peak for Cu(II) species in the sample (which could possibly be CuO or Cu(OH)₂). Using equations (1) and (2), the percentage of Cu(II) and Cu(I)+Cu(0) was calculated for both the samples. As displayed in the bar graph (FIG. 17), the amount of Cu(II) for an uncoated sample was 52% whereas for NHC—Cu surfaces it was 34%, and for Cu(I)+Cu(0) it was 48% and 66% respectively (identified from the average of three independent sets of measurements). These results demonstrate that the removal of surface oxide occurs reliably and reproducibly from the NHC treatment under prevalent experimental conditions. It should be noted that all the reactions and analyses were conducted under ambient conditions, thus the contribution of Cu(I) oxide resulting from interaction with the environment cannot be avoided.

The next step after determining the successful coating of NHC over Cu powder by the described immersion method, was to optimize the synthesis parameters to achieve the optimal coating. The parameters considered for optimization were (1) the stirring effect, (2) the NHC concentration, (3) the immobilization time, and (4) the temperature as depicted in Scheme 2.

While optimizing various reaction variants, the focus was to achieve a maximum decrease in the percentage of Cu (II) species while having a maximum increase in the percentage of N 1s species from XPS, as well as an intense MALDI peak at the m/z ratio of 203 corresponding to the presence of surface [NHC]⁺ species. Another noteworthy aspect is that all the reactions and the transfer to XPS as well as MALDI equipment were performed under ambient conditions which would be advantageous for industrial scale. Therefore, no additional precautions were taken to prevent atmospheric exposure or make the solvent, methanol anhydrous.

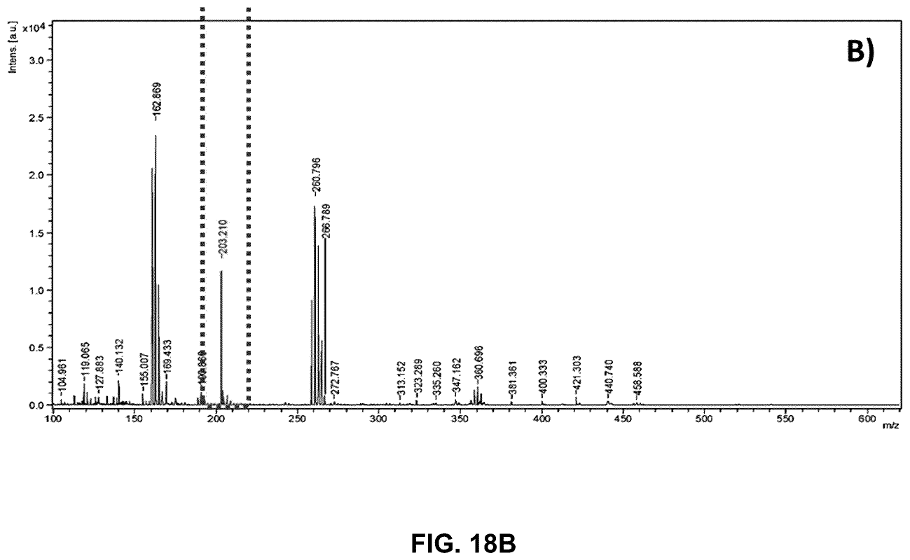

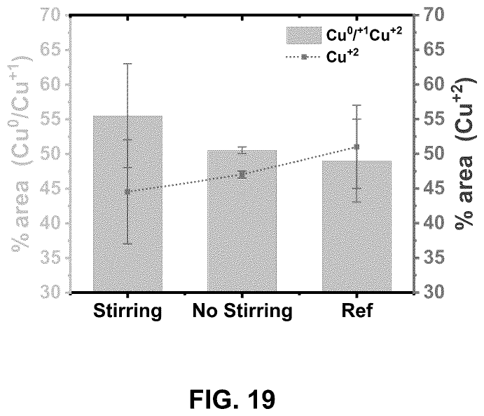

Firstly, the effect of stirring was studied during the immobilization process by performing a control experiment without using stirring conditions and comparing it to an experiment with stirring. The results were analyzed by obtaining MALDI and XPS spectra. As shown in FIGS. 18A-18B, an intense peak at the m/z ratio of 203 was observed for the sample that was prepared under stirring conditions versus the ones without stirring. This confirms that during stirring conditions, the immobilization of NHC is accelerated and optimal resulting in a more uniform coating on the Cu powder. Moreover, more surface oxide reduction (decrease in shakeup peak; FIG. 19) for Cu(II) species is observed when the solution was stirred during the immobilization. Additionally, in order to see any morphological changes plausible from stirring, the coated powder was visualized through SEM. As shown in FIGS. 12A-12B, no significant disintegration or agglomeration of particles was observed after stirring, which suggests that stirring has no adverse effect on particle shape, size, and distribution. Therefore, stirring conditions only assists in the NHC immobilization process compared to the stagnant conditions.

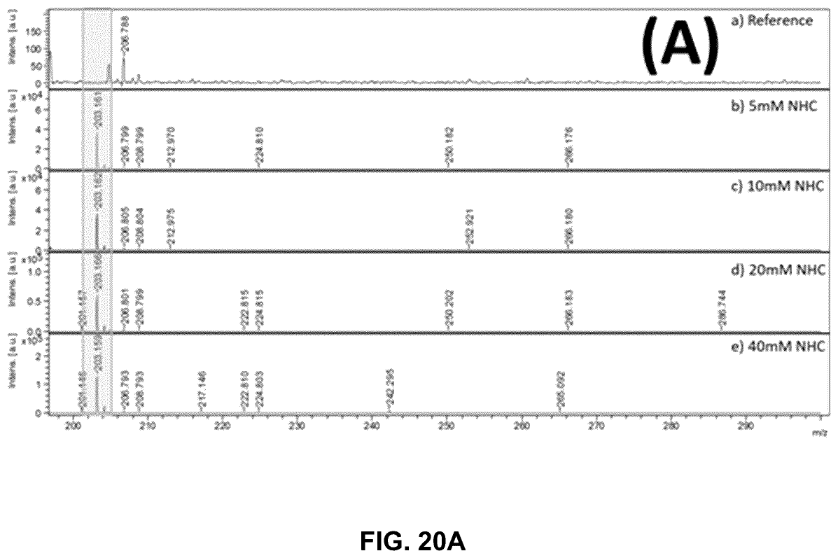

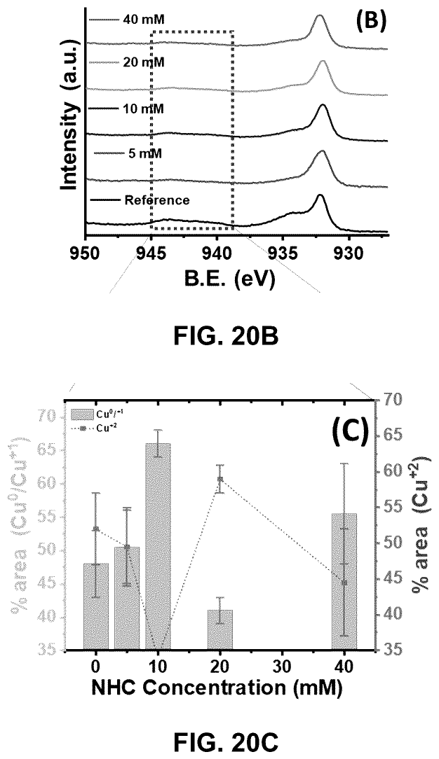

Secondly, NHC concentration was varied during the immobilization in the concentration range of 5 to 40 mM while stirring the solution for 48 h at room temperature. The MALDI spectra in FIG. 20A, shows an increase in the peak intensity for the signature peak (m/z=203) of NHC when the concentration was increased from 5 mM to 40 mM. Before increasing the NHC concentration even more, the findings were first corroborated by performing XPS in order to rule out whether physisorption plays a role in MALDI results. By deconvoluting the Cu 2p spectra, a variation in the oxide removal, as well as shakeup peak, was observed for the different concentration variants contrary to MALDI observations. As shown in FIGS. 20B-20C, the maximum reduction in the shakeup peak area was observed when the concentration was increased from 5 to 10 mM, however, upon further increasing the concentration, less reduction was observed. With further analysis upon fitting the XPS peaks, it was found that maximum removal of Cu (II) species was observed for the 10 mM concentration which achieved a 32.2% decrease in Cu (II) after NHC treatment whereas, other concentrations showed a 10.9% (5 mM), 0.8% (20 mM), and 10.5% (40 mM) decrease in Cu(II). Accordingly, the 10 mM concentration of NHC removes the maximum percentage of surface oxide and also provides an optimal NHC coating under ambient conditions.

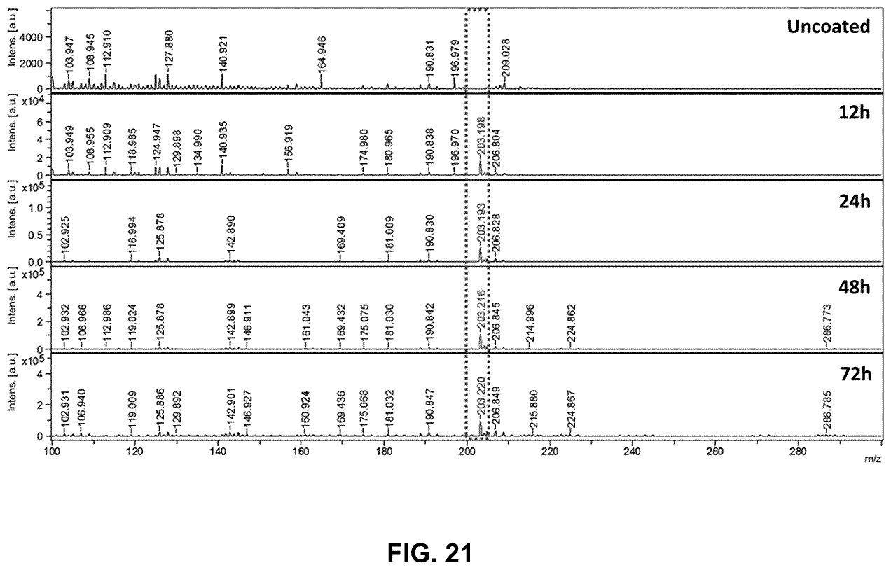

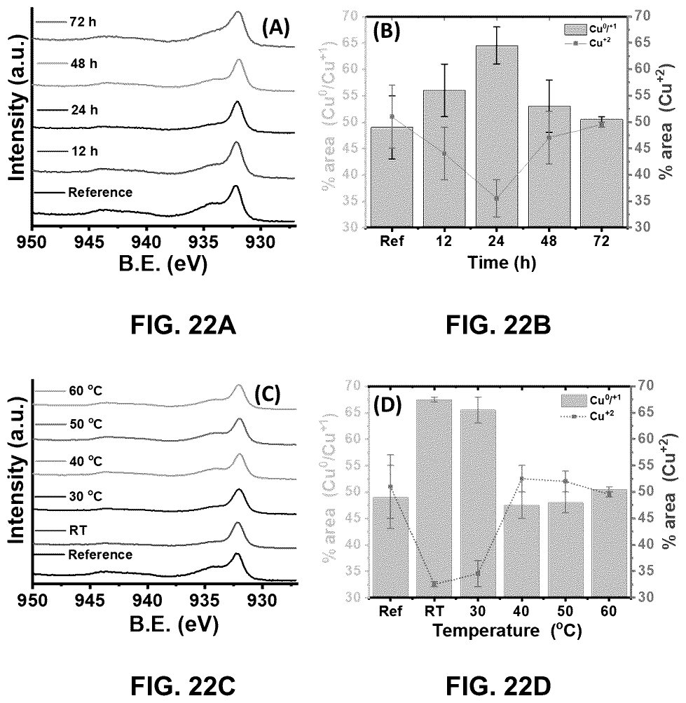

Thirdly, the time of immersion was varied from 12 to 72 h while stirring the solution in 10 mM NHC (previously optimized parameter) at room temperature. As shown in FIG. 21, the intense peak was present in all time variant samples at m/z=203 in MALDI spectra indicating the presence of NHC in all-time variant samples. In order to examine the optimal time period, the Cu 2p spectra of each condition was analyzed in order to determine what condition achieved the maximum reduction of Cu(II) species after NHC treatment. From the Cu 2p spectra (FIGS. 22A-22B), most reduction in the shakeup peak was observed for the 24 h condition beyond which no significant change in the Cu spectra was observed. The peak fitting analysis also confirms that when the immobilization was carried out for 24 h, most reduction in Cu (II) species occurs (30.4%), compared to 13.7%, 7.8%, and 2.9% reduction for 12, 48, and 72 h respectively (see FIGS. 22C-22D). These results of more Cu (II) species on longer durations can be explained by the fact that HCO₃⁻ is produced from the ionization of NHC which, can also act as a source of water that influences the reaction upon increasing its duration. Additional reasoning could be the oxygen interference and moisture environmental contaminations.

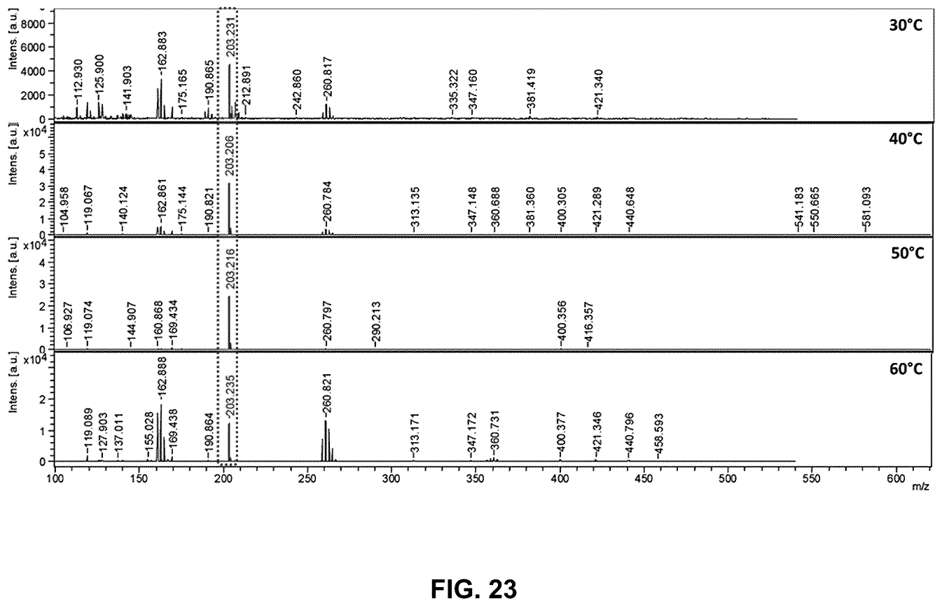

Finally, the last parameter investigated was the effect of temperature ranging from room temperature (RT) to 60° C. while using 10 mM NHC solution for immersion under stirring conditions for 24 h (previously optimized parameters). MALDI-ToF confirmed the NHC presence in all temperature variants at 203 m/z (FIG. 23) but to obtain information regarding oxide reduction at different temperatures, XPS spectra was acquired for each variant. Surprisingly, when the reaction was carried out at 30, 40, 50, and 60° C., higher area for the shakeup peak is seen as compared with RT. Another interesting observation was the variation in the colour of aliquot liquid for the different temperature condition. The colour of settled particles in aliquot changes to blue, as temperature increased from RT to 60° C. reflecting the presence of copper oxidized species such as hydroxides. As shown in the bar graph FIG. 22B, the room temperature variant had the smallest percentage of Cu (II) (37.3% decrease in Cu (II)) compared the conditions at higher temperatures (30, 40, 50, and 60° C.). This could be interference from moisture and oxygen in the environment and anhydrous methanol, a reaction which is favourable at higher temperatures leading to more Cu (II) species.

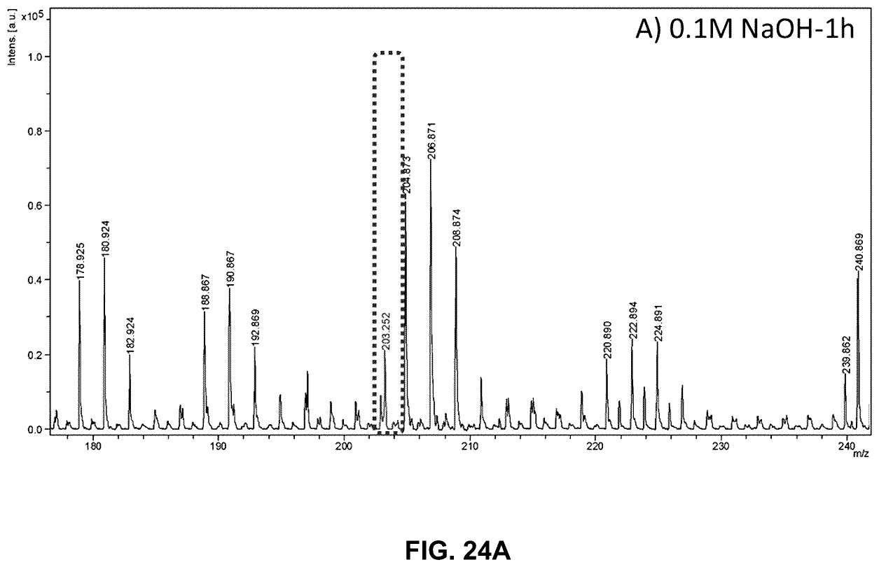

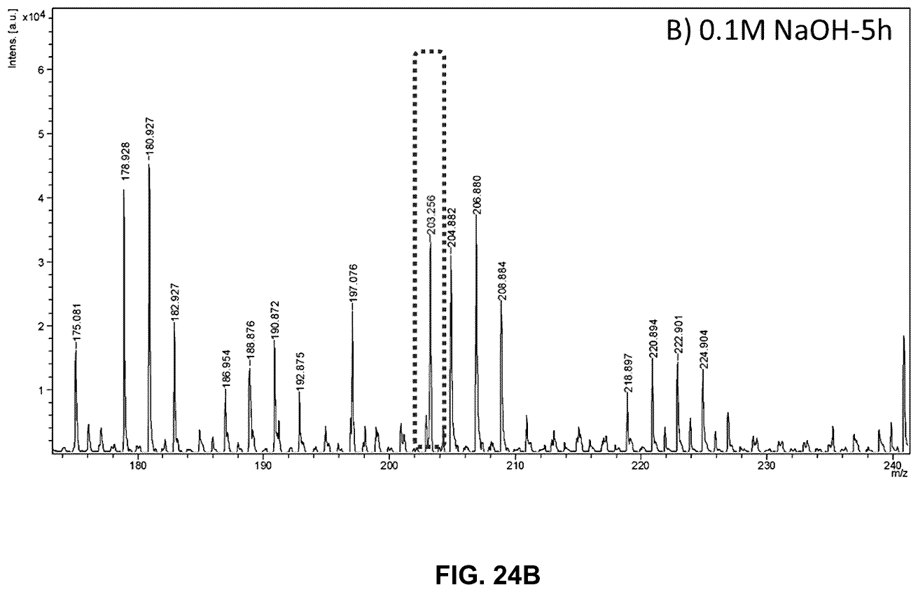

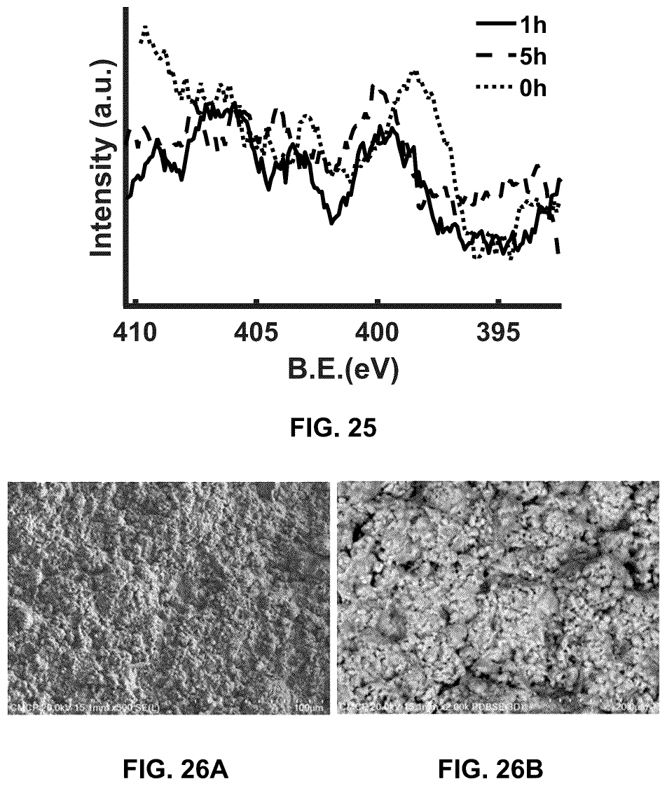

The outcome of the optimization was that when Cu powder is treated with 10 mM NHC under stirring conditions for 24 h at room temperature it results in maximum removal of the surface oxide from the Cu powder without changing the size and morphology of the particles. The result is an optimal NHC coating on Cu powder, which is a potential material for enhancing the corrosion resistance when applied through procedures like spray coating and the like. After achieving an optimal NHC—Cu surface, a stability test was performed in 0.1 M NaOH media. The coated NHC—Cu powder was immersed in the NaOH solution for 1 h and 5 h and the results were analyzed using MALDI-ToF and XPS. Interestingly, MALDI spectra (FIGS. 24A-24B) showed the presence of NHC at 203 m/z even after immersing the NHC—Cu sample in harsh basic conditions. This implies a strong bond between Cu metal and carbon of NHC proving it to be an efficient and strong coating resistant to oxidation. Further investigation for the stability of NHC—Cu sample was done by evaluating N1s spectra. The results indicated the presence of N1s signal for each NaOH immersed variant (FIG. 25) confirming NHC presence, again confirming the resistance to oxidation.

The present example provides a reliable, simple and reproducible one-pot immersion methodology for the removal/reduction of surface oxide and concurrent formation of a self-assembled NHC layer on Cu powders. Initially, the successful coating of NHC over Cu powder was rigorously investigated and proved using XPS and MALDI analysis. Following this confirmation, a stepwise methodology optimization was performed to obtain the most uniform and optimal NHC coating on Cu powder. Moreover, quantitative oxide removal/reduction analysis under various conditions were evaluated by monitoring the disappearance of satellite peaks that belong to Cu (II) species in XPS. Finally, the optimal NHC coating resulted from using 10 mM NHC in MeOH after 24 h of immobilization at room temperature under stirring conditions. Employing this optimized coating methodology, the resulting coating was found to be resistant to oxidation even under harsh acidic and alkaline conditions.

Accordingly, similar results to the mechanochemical deposition were obtained with the immersion method. The immersion method was optimized (Tables 7-10) which revealed that maximum oxide removal occurs under stirring conditions with an NHC concentration of 10 mM, a reaction time of 24 hours, and room temperature.

TABLE 7
Effect on stirring in the immersion method

| | With stirring | Without stirring |
|---|---|---|
| Cu⁰ | 44% | 48% |
| Cu⁺¹ | 44% | 46% |
| Cu⁺² | 12% | 6% |

TABLE 8
Effect on the NHC concentration in the immersion method

| | 0 mm | 5 mm | 10 mm | 20 mm | 40 mm |
|---|---|---|---|---|---|
| Cu⁰ | 7% | 10% | 21% | 9% | 12% |
| Cu⁺¹ | 49% | 44% | 45% | 37% | 44% |
| Cu⁺² | 44% | 45% | 34% | 54% | 44% |

TABLE 9
Effect of time in the immersion method

| | reference | 12 h | 24 h | 48 h | 72 h |
|---|---|---|---|---|---|
| Cu⁰ | 7% | 10% | 17% | 13% | 6% |
| Cu⁺¹ | 48% | 49% | 45% | 47% | 46% |
| Cu⁺² | 44% | 41% | 38% | 40% | 47% |

TABLE 10
Effect of temperature in the immersion method

| | | Room | | | | |
|---|---|---|---|---|---|---|
| | reference | temperature | 30° C. | 40° C. | 50° C. | 60° C. |
| Cu⁰ | 6% | 18% | 15% | 5% | 3% | 4% |
| Cu⁺¹ | 51% | 45% | 45% | 43% | 46% | 45% |
| Cu⁺² | 43% | 37% | 40% | 51% | 50% | 51% |

### Example 3: Carbene-Coated Copper Powder Feedstock for Advanced Thermal Spray Applications

Copper (Cu), revered for its extraordinary thermal and electrical conductivity along with its remarkable resistance to corrosion, plays a pivotal role in various industrial applications. Despite its stellar attributes, the persistent challenge of surface oxidation necessitates advanced strategies to mitigate the formation of oxide layers considering temperature as a variable. Addressing such variability is essential for developing versatile strategies that can effectively combat oxidation across a spectrum of operational temperatures. As demonstrated in the previous examples, a surface modification technique was presented where oxide reduction and the formation of a protective surface layer occurred on the Cu. More specifically, this approach revolves around surface-anchoring an organic layer on copper powder through electrochemical deposition methods.

The optimized modified copper powder surface, not only exhibits remarkable stability under severe basic conditions (0.1 M NaOH) but also showcases its potential prowess in safeguarding copper feedstock powder within thermal spray applications, particularly when employed in HVAF and CS. Beyond the technical merits, the ease of operation and efficiency of these methods emerge as significant highlights. It holds the potential of not just addressing the immediate challenges posed by oxide formation but also significantly extending the overall lifespan of copper coatings. This transformative approach carries tangible benefits, not only in terms of technical advancements but also in resource conservation, time efficiency, and cost-effectiveness, making it an invaluable prospect poised to positively impact a wide spectrum of industries.

The research significantly emphasizes the effectiveness of high-velocity air fuel (HVAF) and cold spray (CS) as robust methods for the application of such modified copper powder. This study employs a comprehensive range of sophisticated characterization techniques, such as scanning electron microscopy (SEM) and scanning Transmission electron microscopy (STEM). This multifaceted approach ensures a thorough examination of both microstructural features and the modified copper surface within the coatings.

TABLE 11
HVAF spraying parameters

| | |
|---|---|
| Air flow rate (L/min) | 3401 |
| Air pressure (psi, MPa) | 128 (0.86) |
| Fuel flow rate (g/min) | 184 |
| Fuel pressure (psi, MPa) | 110 (0.78) |
| Gun travel speed (mm/s) | 1000 |
| Number of passes | 40 |
| Powder feed rate (g/min) | 25 |

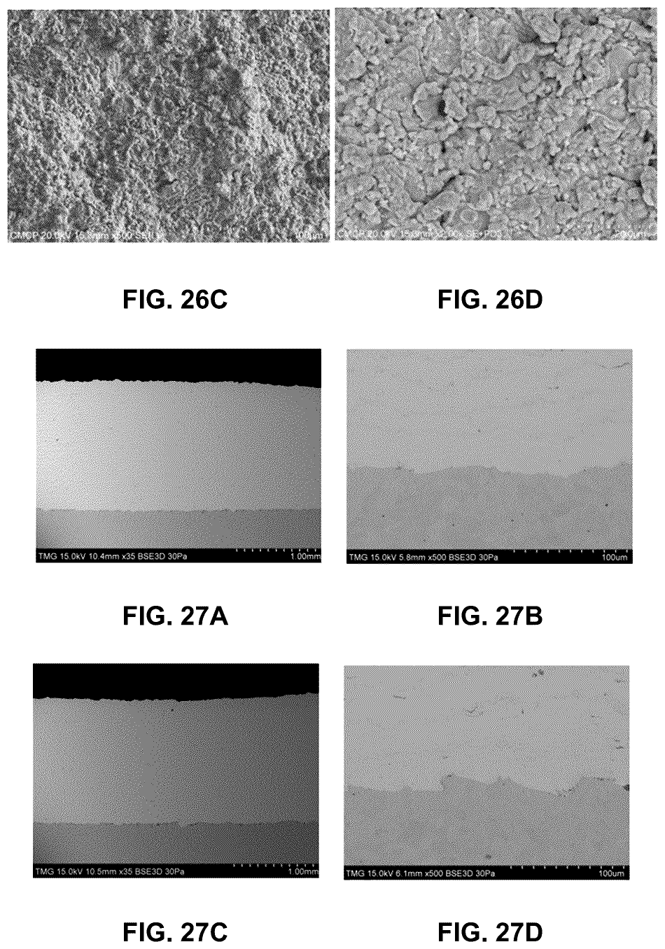

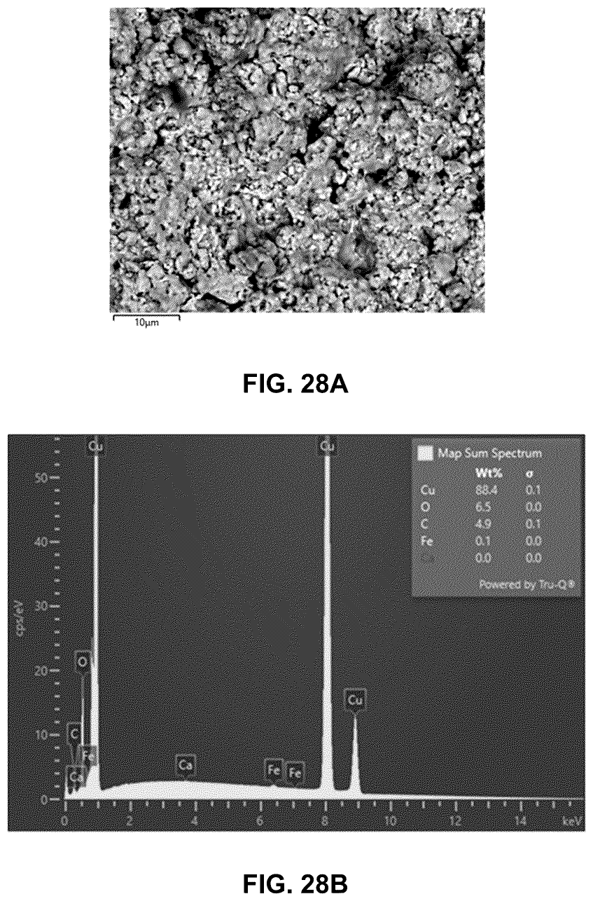

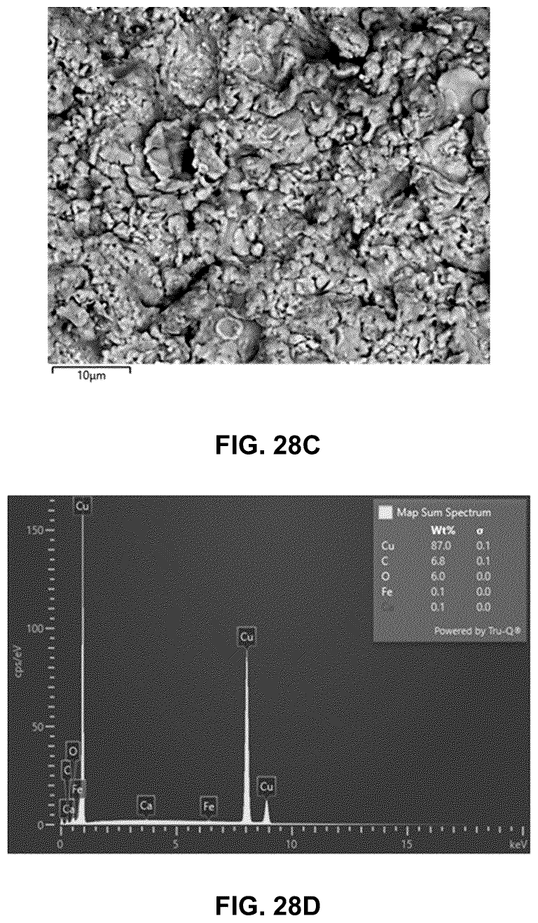

HVAF spraying was performed according to the parameters of Table 11 for a Cu and a Cu—NHC coating. The results obtained from the comprehensive analysis of the Cu and Cu—NHC coatings through SEM and energy-dispersive X-ray spectroscopy (EDS) illuminate the success and high-quality characteristics of the coatings as illustrated in FIGS. 26A-26D, 27A-27D and 28A-28D. As can be seen in these figures, both coatings have a dense and uniform microstructure as well as having a smooth surface. The Cu—NHC coatings, obtained through the optimized surface modification technique, exhibit a remarkably dense and uniform microstructure under SEM examination. The EDS results shown in FIGS. 28B and 28D affirm the effective anchoring of the organic layer on the copper powder, showcasing a balanced elemental composition conducive to enhanced properties such as having less amount of oxygen on the surface.

HVAF, as the chosen application method, plays an important role in having a fairly dense microstructure of the coatings. The high-quality attributes of the coatings are not simply confined to their structural characteristics but extend to their performance under specific conditions. The coatings demonstrate stability even when subjected to a harsh environment, highlighting their resilience and suitability for diverse applications. In essence, the SEM and EDS results serve as a validation of the effectiveness of the surface modification technique employed. The microstructural uniformity and elemental composition of the coatings, coupled with their high-quality attributes obtained through HVAF, underscore the success of this innovative approach in achieving coatings with desirable properties.

The corrosion behavior of thermally sprayed coupons was analyzed in an aqueous electrolyte solution composed of 3.5% NaCl. Prior to the corrosion measurements, the coupons were polished using different grades of SiC paper ranging from 800, 1200, and 4000.

Post polishing, the coupons were electrochemically tested in a flat cell composed of a three-electrode setup, where the coupon itself was used as the working electrode (exposed area 1 cm²), Pt-mess as counter, and saturated calomel electrode (SCE) as a reference electrode.

Once the setup was ready, open circuit potential (OCP) measurements were performed for 6 h followed by the electrochemical impedance spectroscopy (EIS) measurements in a potentiostatic mode where the voltage perturbation amplitude was 10 mV (Vrms=7.07 mV) in the frequency range of 500 kHz to 100 mHz.

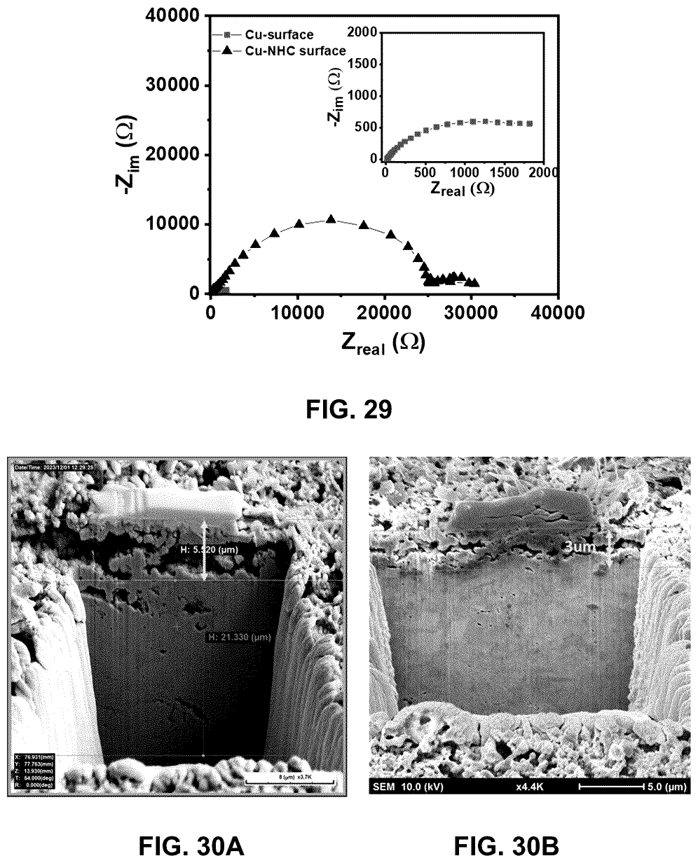

As shown in FIG. 29, a higher charge transfer resistance (R_{ct}=24115Ω) was observed for the Cu—NHC surface vs. bare Cu surface (R_{ct}=1580Ω), indicating a higher corrosion resistance. The higher charger transfer resistance can be explained by the increased inter-particle bonding due to the removal of particle surface oxide. These results are well supported by the focused ion beam coupled with a scanning electron microscope (FIB-SEM) by selectively etching the corroded surface (post-corrosion) for both Cu—NHC and Cu surface, where less penetration of ions is observed for the Cu—NHC surface compared to the Cu surface (FIGS. 30A-30B).

### Example 4: Aluminum and Titanium Powders Coated with NHC

The above examples 1-3 used copper as the metal for the metal powder. However, as explained above, other metals can be used instead of copper and this is demonstrated in the present example with Al and Ti as examples. The aluminum powder selected was AlSi₅Mg and the titanium powder was Ti₆Al₄V. A NHC-0005 was deposited by mechanochemistry as described in Example 1 on the Al and Ti powders (Table 12-13). iPr-NHC and Meso-NHC were also used on the Al and Ti powders (Tables 14-15) and deposited by mechanochemistry as described in Example 1. The atomic percentage in the powders was analyzed by XPS to determine the metallic content. As can be seen from Tables 12-15, the mechanochemistry method previously shown to work on Cu also worked for Ti and Al powders.

TABLE 12
XPS analysis of Al powder

| | Powder as | Powder before NHC | Al with NHC |
|---|---|---|---|
| | received | treatment | treatment |
| Al⁰ % (atomic | 21 | 24 | 29 |
| percentage of Al | | | |
| metallic) | | | |
| dₒₓᵢ (oxide layer | 32 | 30 | 26 |
| thickness in | | | |
| Angstroms) | | | |

TABLE 13
XPS analysis of Ti powder

| | Powder as | Powder before NHC | Al with NHC |
|---|---|---|---|
| Atomic percentage | received | treatment | treatment |
| Ti (IV) | 86% | 85% | 81% |
| Ti (III) | 3% | 4.5% | 5% |
| Ti (II) | 2% | 2.5% | 2.5% |
| Ti (0) | 8% | 8% | 11.5% |

TABLE 14
XPS analysis of Al powder

| | Reference | iPr-NHC 1 h | iPr-NHC 2.5 h | iPr-NHC 5 h | Meso-NHC 5 h |
|---|---|---|---|---|---|
| Al⁰ % (atomic | 18 | 17.5 | 16 | 22 | 24 |
| percentage of Al | | | | | |
| metallic) | | | | | |
| dₒₓᵢ (oxide layer | 58 | 58 | 60 | 50 | 48 |
| thickness in | | | | | |
| Angstroms) | | | | | |

TABLE 15
XPS analysis of Ti powder

| | | | | | iPr- | Meso- |
|---|---|---|---|---|---|---|
| Atomic | As | Before | iPr-NHC | iPr-NHC | NHC | NHC |
| percentage | received | treatment | 1 h | 2.5 h | 5 h | 5 h |
| Ti (IV) | 80% | 81% | 76% | 76% | 76% | 70% |
| Ti (III) | 10% | 11% | 6% | 9% | 10% | 11% |
| Ti (II) | 2% | 1% | 5% | 4% | 3% | 5% |
| Ti (0) | 8% | 7% | 13% | 11% | 11% | 14% |

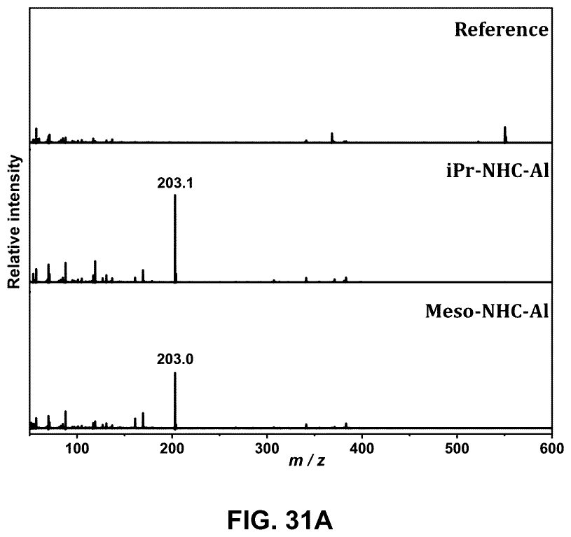

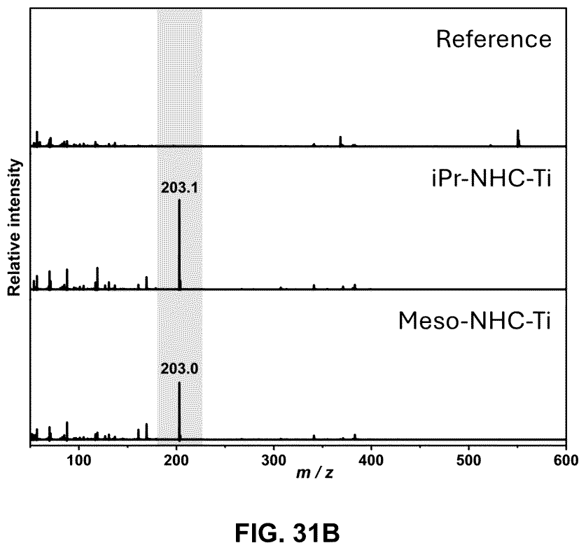

To demonstrate that NHC was present on the surface of Ti and Al powders, matrix-assisted laser desorption/ionization (MALDI) was used. The mass spectra obtained from samples treated with iPr-NHC and Meso-NHC showed a peak for these molecules (FIGS. 31A-31B), which both have a mass of 203 m/z (exact mass=203.15 m/z). In contrast, the untreated powder does not show this ion. The spectra were obtained after the washing procedure.

What is claimed is:

1. A method of producing a N-heterocyclic carbene (NHC) coated metal powder, the method comprises: mixing an alcohol solvent, metal powder and a N-heterocyclic carbene (NHC) salt to obtain a NHC coated metal powder.

2. The method of claim 1, wherein the metal is selected from Ti, Ni, Al, Cu, and Fe and alloys thereof.

3. The method of claim 1, wherein the alcohol solvent is selected from methanol, ethanol, butanol or propanol.

4. The method of claim 1, further comprising separating the NHC coated metal powder from the alcohol solvent.

5. The method of claim 1, wherein the mixing is performed at a temperature of from 18 to 25° C.

6. The method of claim 1, wherein the mixing is performed at atmospheric pressure.

7. The method of claim 1, wherein metal powder has a particle size distribution characterized by a D50 of from 5 to 200 μm.

8. The method of claim 1, wherein the metal powder has a size in the range of from 1 to 300 μm.

9. The method of claim 1, further comprising, washing the NHC coated metal powder with the alcohol to remove the NHC salt.

10. The method of claim 9, wherein the washing is repeated at least 3 times.

11. The method of claim 1, wherein the mixing comprises resonance acoustic mixing (RAM).

12. The method of claim 11, wherein the alcohol solvent is provided in a volume to weight ratio with respect to the metal powder of from 5 μL per g to 500 μL per g.

13. The method of claim 11, wherein the NHC salt is provided in the mixing such that a weight ratio of the NHC salt to the metal powder is from 1:10 to 1:2000.

14. The method of claim 11, wherein the mixing is performed at an acceleration ranging from 20 to 100 G.

15. The method of claim 11, wherein the mixing is performed for between 30 mins and 5 hours.

16. The method of claim 1, wherein the mixing is performed under immersion in the alcohol solvent.

17. The method of claim 16, wherein the NHC salt is provided in a concentration of 5 to 40 mM.

18. The method of claim 16, wherein the metal powder is provided in a concentration of from 0.1 to 5 g/mL.

19. The method of claim 16, wherein the mixing is performed for a duration of 20 to 28 h.

20. A method of reducing oxide species at a surface of a metal powder producing a NHC coated metal powder, the method comprising performing the method as defined in claim 1.
